(19) United States
(12) Patent Application Publication
(10) Pub. No.: US 2026/0299450 A1
(43) Pub. Date: Oct. 1, 2026

(54) ELECTROSTATIC CHARGE IMAGE DEVELOPING TONER, ELECTROSTATIC CHARGE IMAGE DEVELOPER, TONER CARTRIDGE, PROCESS CARTRIDGE, AND IMAGE FORMING APPARATUS

(71) Applicant: FUJIFILM Business Innovation Corp., Tokyo (JP)

(72) Inventors: Kotaro YOSHIHARA, Kanagawa (JP); Tsuyoshi Murakami, Kanagawa (JP); Asafumi Fujita, Kanagawa (JP); Tomoaki Tanaka, Kanagawa (JP)

(73) Assignee: FUJIFILM Business Innovation Corp., Tokyo (JP)

(21) Appl. No.: 19/309,781

(22) Filed: Aug. 26, 2025

(30) Foreign Application Priority Data
Mar. 26, 2025 (JP) 2025-052630

(51) Int. Cl. G03G 9/09; G03G 9/08

(52) U.S. Cl. CPC G03G 9/091; G03G 9/0819; G03G 2215/0604; G03G 2215/066; G03G 2221/183

(57) ABSTRACT

An electrostatic charge image developing toner includes a toner particle containing a binder resin, a pigment containing a fluorescent pigment, and a release agent, in which a cross-section of the toner particle is observed, the cross-section includes a domain of the release agent, and a contact ratio of the pigment to the domain of the release agent is 5% or more and 30% or less.

### CROSS-REFERENCE TO RELATED APPLICATIONS

This application is based on and claims priority under 35 USC 119 from Japanese Patent Application No. 2025-052630 filed Mar. 26, 2025.

### BACKGROUND

### (i) Technical Field

The present disclosure relates to an electrostatic charge image developing toner, an electrostatic charge image developer, a toner cartridge, a process cartridge, and an image forming apparatus.

### (ii) Related Art

Methods of visualizing image information, such as an electrophotographic method, are currently used in various fields. In such an electrophotographic method, the surface of an image holding member is charged, and then an electrostatic charge image is formed as image information. A toner image is formed on the surface of the image holding member by using a developer containing a toner. The toner image is transferred to a recording medium and then fixed to the recording medium. Through these steps, the image information is visualized as an image.

For example, Japanese Unexamined Patent Application Publication No. 2020-106601 discloses “a cyan toner in which, in a cross-section of the cyan toner observed by using a transmission electron microscope (TEM), a structure in which a wax is coated with a copper-phthalocyanine pigment is present”.

Japanese Unexamined Patent Application Publication No. 2023-174245 discloses “a green toner containing green toner particles in which a mass-based ratio of a content M2 of the non-fluorescent pigment to a content M1 of the azomethine fluorescent pigment is 0.05 or more and 1.5 or less, and a total content of the azomethine fluorescent pigment and the non-fluorescent pigment with respect to a total amount of the green toner particles is 5% by mass or more and 15% by mass or less”.

### SUMMARY

Aspects of non-limiting embodiments of the present disclosure relate to providing an electrostatic charge image developing toner that exhibits higher fluorescence intensity and can form an image with further reduced dot-shaped image defects than an electrostatic charge image developing toner including a toner particle containing a binder resin, a pigment containing a fluorescent pigment, and a release agent, in which when a cross-section of the toner particle is observed, the cross-section includes a domain of the release agent, and a contact ratio of the pigment to the domain of the release agent is less than 5% or more than 30%.

Aspects of certain non-limiting embodiments of the present disclosure address the above advantages and/or other advantages not described above. However, aspects of the non-limiting embodiments are not required to address the advantages described above, and aspects of the non-limiting embodiments of the present disclosure may not address advantages described above.

According to an aspect of the present disclosure, there is provided an electrostatic charge image developing toner including a toner particle containing a binder resin, a pigment containing a fluorescent pigment, and a release agent, in which when a cross-section of the toner particle is observed, the cross-section includes a domain of the release agent, and a contact ratio of the pigment to the domain of the release agent is 5% or more and 30% or less.

### BRIEF DESCRIPTION OF THE DRAWINGS

Exemplary embodiments of the present disclosure will be described in detail based on the following figures, wherein:

FIG. 1 is a schematic configuration view illustrating an example of an image forming apparatus according to the present exemplary embodiment; and

FIG. 2 is a schematic configuration view illustrating an example of a process cartridge to be attached to and detached from the image forming apparatus according to the present exemplary embodiment.

### DETAILED DESCRIPTION

Hereinafter, exemplary embodiments of the present disclosure will be described. These descriptions and examples are intended to be illustrative of the exemplary embodiments and are not intended to limit the scope of the exemplary embodiments.

In the present specification, a numerical range expressed using “to” means the range that includes the values described before and after “to” as the minimum and maximum values, respectively.

In the numerical ranges described stepwise in the present disclosure, the upper limit value or lower limit value described in one numerical range may be replaced with the upper limit value or lower limit value of another numerical range described stepwise. In a numerical range described in the present specification, the upper limit value or lower limit value in the numerical range may be replaced with a value presented in Examples.

In the present specification, the term “step” includes not only an independent step but also a step that cannot be clearly distinguished from another step as long as the purpose of the step is achieved.

In the present specification, when an exemplary embodiment is described with reference to the drawings, the configuration of the exemplary embodiment is not limited to the configuration illustrated in the drawings. The sizes of the members in the drawings are conceptual and do not limit the relative relationship in size between the members.

In the present specification, each component may contain a plurality of kinds of corresponding substances. In the present disclosure, when referring to the amount of each component in a composition, in a case where a plurality of kinds of substances corresponding to each component are present in the composition, the amount means the total amount of the plurality of kinds of substances present in the composition unless otherwise stated.

In the present specification, each component may include a plurality of kinds of particles that correspond to the component. In a case where a plurality of kinds of particles corresponding to each component are present in a composition, the particle diameter of each component means a value for a mixture of the plurality of kinds of particles present in the composition unless otherwise stated.

### Electrostatic Charge Image Developing Toner

The electrostatic charge image developing toner according to the present exemplary embodiment (hereinafter also referred to as “toner”) includes toner particles containing a binder resin, a pigment containing a fluorescent pigment, and a release agent.

When the cross-section of a toner particle is observed, the toner particle has a domain of the release agent, and the contact ratio of the pigment to the domain of the release agent is 5% or more and 30% or less.

With the above configuration, the toner according to the present exemplary embodiment exhibits high fluorescence intensity and can form an image with reduced dot-shaped image defects. The reason for this is presumed to be as follows.

In the related art, it is known to use a toner to which a pigment containing a fluorescent pigment is applied for widening the color gamut of images (hereinafter also referred to as “fluorescent toner”).

Development of a fluorescent color in an image formed using a fluorescent toner involves designing the chroma and lightness of the toner to be high. The methods therefor include a method of increasing the dispersion diameter of the fluorescent pigment in the fluorescent toner particles for increasing the reflectance of the fluorescent pigment.

However, the release agent having a low affinity for the fluorescent pigment is likely to have a large domain in the fluorescent toner particles. Therefore, the fluorescent toner particles tend to exhibit a large dispersion diameter of each constituent component and uneven distribution of the constituent components.

In such a case, among the fluorescent toners having a certain particle size distribution, a smaller-diameter fluorescent toner (i.e., fine powder toner) easily causes the exposure of the fluorescent pigment or the release agent as a single substance from the fluorescent toner particles. For this reason, the mechanical load and the thermal load easily cause the deformation of toner particles, the elimination of components, and the adhesion to the members in the image forming apparatus.

In particular, when images are formed on both sides of the recording medium, the temperature of the developing device (specifically, a developer-layer-restricting member called a trimmer) easily rises due to the temperature rise in the machine, which decreases the fluidity of the toner particles in which the fluorescent pigment or the release agent is exposed as a single substance. This facilitates the adhesion of constituent components of the fluorescent toner to members and the deterioration of the fluorescent toner, which further degrades the fluidity of the fluorescent toner. The fluorescent toner whose fluidity has been degraded is likely to accumulate on the developer-layer-restricting member and is subjected to a greater thermal load.

In addition, when images whose image density is from low to medium are continuously formed, a small-diameter toner difficult to be developed tends to accumulate on the developer-layer-restricting member. In such a situation, when the temperature in the machine decreases after the completion of image formation on both sides of the recording medium, the small-diameter toner subjected to a thermal load is likely to form an aggregate. The formed aggregates are less likely to be transferred in the transfer step and cause dot-shaped image defects.

On the other hand, in the fluorescent toner in which the dispersion diameter of each constituent component is large and the constituent components are unevenly distributed, the pigment is hardly dispersed in the image, which impairs the fluorescence intensity.

In contrast to the above, in the toner according to the present exemplary embodiment, the contact ratio of the pigment to the domain of the release agent is set to 5% or more and 30% or less. That is, the contact ratio of the pigment containing the fluorescent pigment is set to 5% or more and 30% or less.

When the pigment containing the fluorescent pigment is appropriately disposed around the domain of the release agent in this manner, the fluorescent pigment functions as a spacer even if the release agent is exposed on the surfaces of the toner particles. With this configuration, a decrease in the fluidity of the toner and the generation of aggregates can be reduced. Thus, the occurrence of dot-shaped image defects can be suppressed.

Additionally, the release agent melts and the pigment containing the fluorescent pigment spreads within the image during the fixing of the toner image. This improves the dispersion of the pigment in the image. As a result, high fluorescence intensity can be exhibited.

As described above, the toner according to the present exemplary embodiment is presumed to exhibit high fluorescence intensity and can form an image with reduced dot-shaped image defects.

Hereinafter, the toner according to the present exemplary embodiment will be described in detail.

The toner according to the present exemplary embodiment includes toner particles. The toner according to the present exemplary embodiment may contain an external additive.

### Properties of Toner Particles

### Contact Ratio of Pigment to Domain of Release Agent

The observed cross-section of a toner particle includes a domain of the release agent. The contact ratio of the pigment to the domain of the release agent is 5% or more and 30% or less. The contact ratio of the pigment is preferably 10% or more and 25% or less, more preferably 10% or more and 20% or less.

When the contact ratio of the pigment is 5% or more, the pigment functions as a spacer even if the release agent is exposed on the surfaces of the toner particles. With this configuration, a decrease in the fluidity of the toner and the generation of aggregates can be reduced. Thus, the occurrence of dot-shaped image defects can be suppressed. In addition, the dispersion of the pigment in a toner image is improved during the fixing of the toner image. Hence, an image exhibiting high fluorescence intensity can be obtained.

When the contact ratio of the pigment is 30% or less, the inhibition of seepage of the release agent from the toner particles during fixing due to an excessive amount of pigment present around the domain of the release agent is suppressed. Thus, a decrease in pigment dispersibility during the fixing of the toner image is suppressed. As a result, a decrease in the fluorescence intensity of an image is suppressed.

Examples of the method of controlling the contact ratio of the pigment within the above-described range include a method using, as a pigment dispersion liquid, a pigment-/release agent particle-mixed dispersion liquid in which a pigment and release agent particles are dispersed, when toner particles are produced by an aggregation-coalescence method.

### Area Fraction of Domain of Release Agent Present in Surface Layer Region

When the cross-section of a toner particle is observed, the area fraction of the domain of the release agent present in a region within a distance of 0.3× d (where d represents the volume-average particle diameter of toner particles) from the surface of the toner particle in a direction of the center of gravity of the cross-section of the toner particle (hereinafter, this region is also referred to as a “surface layer region”) is preferably 50% or more and 90% or less, more preferably 50% or more and 70% or less, still more preferably 50% or more and 60% or less.

When the area fraction of the domain of the release agent present in the surface layer region is 50% or more, the seepage of the release agent from the toner particles during fixing is improved. This improves the dispersion of the pigment in a toner image during the fixing of the toner image. Thus, an image exhibiting higher fluorescence intensity can be obtained.

When the area fraction of the domain of the release agent present in the surface layer region of the toner image is 90% or less, the amount of the release agent present in the central portion of the toner particle is small, and the amount of the release agent in the fixed image can be reduced. As a result, an image exhibiting higher fluorescence intensity can be obtained.

Examples of the method of controlling the area fraction of the domain of the release agent present in the surface layer region to fall within the above-described range include a method using a release agent particle dispersion liquid together with a resin particle dispersion liquid in a second aggregation step of forming a coating layer (shell layer) during the production of toner particles having a core-shell structure by an aggregation-coalescence method.

### Domain Diameter of Release Agent and Dispersion Diameter of Fluorescent Pigment

When the cross-section of the toner particle is observed, the ratio of the dispersion diameter of the fluorescent pigment to the domain diameter of the release agent (dispersion diameter of fluorescent pigment/domain diameter of release agent) is preferably 1/10 or more and 4/5 or less, more preferably 1/3 or more and 3/5 or less, still more preferably 1/3 or more and 1/2 or less.

When the ratio of the dispersion diameter of the fluorescent pigment to the domain diameter of the release agent is 1/3 or more, the fluorescent pigment easily functions as a spacer even if the release agent is exposed on the surfaces of the toner particles. This makes it possible to further suppress a decrease in the fluidity of the toner and the generation of aggregates. Thus, the occurrence of dot-shaped image defects can be suppressed. In addition, the dispersion of the pigment in a toner image is further improved during the fixing of the toner image. Thus, an image exhibiting higher fluorescence intensity can be obtained.

When the ratio of the dispersion diameter of the fluorescent pigment to the domain diameter of the release agent is 4/5 or less, the inhibition of seepage of the release agent from the toner particles during fixing due to the fluorescent pigment present around the domain of the release agent is further suppressed. Thus, a decrease in pigment dispersibility during fixing of a toner image can be further suppressed. As a result, a decrease in the fluorescence intensity of the image is further suppressed.

From the viewpoints of improving the fluorescence intensity and suppressing the occurrence of dot-shaped image defects, the dispersion diameter of the fluorescent pigment upon observing the cross-section of the toner particle is preferably 50 nm or more and 800 nm or less, more preferably 100 nm or more and 500 nm or less.

From the same viewpoints, the domain diameter of the release agent upon observing the cross-section of the toner particle is preferably 100 nm or more and 1500 nm or less, more preferably 100 nm or more and 1000 nm or less.

When the pigment contains a non-fluorescent pigment, the ratio of the dispersion diameter of the fluorescent pigment to the dispersion diameter of the non-fluorescent pigment is preferably 1/25 or more and 1/2 or less, more preferably 1/10 or more and 1/2 or less.

When the ratio of the dispersion diameter of the fluorescent pigment to the dispersion diameter of the non-fluorescent pigment falls within the above-described range, a domains having an appropriate size can be formed in the fixed image. In addition, since the non-fluorescent pigment in the fixed image is finely dispersed, color can be developed without impairing the fluorescence. This results in facilitating formation of an image exhibiting high fluorescence intensity with reduced dot-shaped image defects.

Examples of the method of controlling the domain diameter of the release agent include a method of controlling the dispersion diameter in a release agent dispersion liquid and a method of controlling the temperature during manufacturing of a toner.

Examples of the method of controlling the dispersion diameter of pigments (fluorescent pigment and non-fluorescent pigment) include a method of controlling the dispersion diameter in a pigment dispersion liquid and a method of controlling the composition in a dispersion liquid.

### Method of Observing Cross-Section of Toner Particle and Various Measurement Methods

### Method of Observing Cross-Section of Toner Particle

The method of observing the cross-section of the toner particle is as follows.

The toner particles to be measured (or toner particles to which an external additive adheres) are mixed with and embedded in an epoxy resin, and the epoxy resin is solidified. The resulting solidified product is cut using an ultramicrotome (Ultracut UCT manufactured by Leica Microsystems) to produce a thin sample having a thickness of 80 nm or more and 130 nm or less. Next, the obtained thin sample is stained with ruthenium tetroxide in a desiccator at 30° C. for three hours. Then, using an ultra-high-resolution field emission scanning electron microscope (FE-SEM, S-4800 manufactured by Hitachi High-Tech Corporation), an STEM observation image (magnification: 20,000×) of the stained thin sample in a transmission image mode is obtained.

In the image, resins (amorphous resin and crystalline resin) are distinguished from the release agent on the basis of contrast and shape. Ruthenium staining makes the amorphous resin (e.g., amorphous polyester resin) to be stained most intensely, the crystalline resin (e.g., crystalline polyester resin) to be stained second most intensely, and the release agent to be stained most slightly. By adjusting the contrast, the amorphous resin is observed in black, the crystalline resin in light gray, and the release agent in white.

On the other hand, the pigment is observed in black by performing a treatment according to a method the same as or similar to the above-described method except for staining. When both the fluorescent pigment and the non-fluorescent pigment are contained in the toner particles, the fluorescent pigment and the non-fluorescent pigment can be distinguished from each other because the fluorescent pigment is observed in black and the non-fluorescent pigment is observed in slightly pale black.

However, when the distinction between the fluorescent pigment and the non-fluorescent pigment by color is difficult, a pigment having a larger dispersion diameter is determined to be a fluorescent pigment, and a pigment having a smaller dispersion diameter is determined to be a non-fluorescent pigment. Specifically, a pigment having a dispersion diameter (here, equivalent circle diameter) of 50 nm or more is considered as a fluorescent pigment, and a pigment having a dispersion diameter (here, equivalent circle diameter) of less than 50 nm is considered as a non-fluorescent pigment.

### Method of Measuring Contact Ratio of Pigment

In the observation of the cross-section of the toner particle as described above, the contact ratio of the pigment to the domain of the release agent is measured as follows.

The perimeters of all domains of the release agent present in the cross-section of one toner particle are analyzed. Of the perimeters of all domains of the release agent, the length of a portion where the domains of the release agent are in contact with the fluorescent pigment is analyzed. The obtained ratio of the length of a portion where the domains of the release agent are in contact with the fluorescent pigment to the perimeters of the domains of the release agent is calculated as a contact ratio of the pigment to the domain of the release agent.

These operations are performed on 50 toner particles, and the obtained contact ratios of the pigment to the domain of the release agent are arithmetically averaged.

### Area Fraction of Domain of Release Agent

In the observation of the cross-section of the toner particle as described above, the area fraction of the domain of the release agent present in the surface layer region is measured as follows.

The areas of all domains of the release agent present in the cross-section of one toner particle are analyzed. Among such areas, the areas of domains of the release agent present in a region within a distance of 0.3×d from the surface of the toner particle in a direction of the center of gravity of the cross-section of the toner particle are analyzed (where d represents a volume-average particle diameter of toner particles). The ratio of the area of the domains of the release agent present in the surface layer region to the area of all the domains of the release agent present in the cross-section of one toner particle is calculated.

These operations are performed on 50 toner particles, and the obtained area fractions of the domains of the release agent present in the surface layer regions are arithmetically averaged.

### Method of Measuring Domain Diameter of Release Agent

In the observation of the cross-section of the toner particle as described above, the domain diameter of the release agent is measured as follows.

The equivalent circle diameters of all domains of the release agent present in the cross-section of one toner particle are measured.

These operations are performed on 50 toner particles, and the obtained domain diameters of the release agent are arithmetically averaged. The obtained value is defined as a domain diameter of the release agent.

### Method of Measuring Dispersion Diameter of Pigment

In the observation of the cross-section of the toner particle as described above, the dispersion diameter of the pigment (fluorescent pigment and non-fluorescent pigment) is measured as follows.

The equivalent circle diameters of 10 particles of the fluorescent pigment and 10 particles of the non-fluorescent pigment observed in the cross-section of one toner particle are measured. When the pigment is observed in the state of primary particles, the equivalent circle diameter is defined as an equivalent circle diameter of the primary particle. When the pigment is present in a state of secondary particles due to aggregation, the equivalent circle diameter is defined as an equivalent circle diameter of the secondary particle.

These operations are performed on 50 toner particles, and the obtained equivalent circle diameters of the fluorescent pigment and the non-fluorescent pigment are used to obtain a number-based particle size distribution.

The peak values of the equivalent circle diameters of the fluorescent pigment and the non-fluorescent pigment in the particle size distribution are defined as dispersion diameters of the fluorescent pigment and the non-fluorescent pigment, respectively.

For each of the fluorescent pigment and the non-fluorescent pigment, when there are two or more peak values of the equivalent circle diameter in the particle size distribution, the arithmetic average value of the two or more peak values is defined as a dispersion diameter.

### Composition of Toner Particle

The toner particle includes a binder resin, a pigment containing a fluorescent pigment, and a release agent. The toner particle may include a resin other than the binder resin, other additives, and the like.

The binder resin is not particularly limited and may be appropriately selected in accordance with the intended purpose. Examples of the binder resin include vinyl-based resins including a homopolymer of a monomer, such as styrenes (e.g., styrene, p-chlorostyrene, and a-methylstyrene), (meth)acrylic acid esters (e.g., methyl acrylate, ethyl acrylate, n-propyl acrylate, n-butyl acrylate, lauryl acrylate, 2-ethylhexyl acrylate, methyl methacrylate, ethyl methacrylate, n-propyl methacrylate, lauryl methacrylate, and 2-ethylhexyl methacrylate), ethylenically unsaturated nitriles (e.g., acrylonitrile and methacrylonitrile), vinyl ethers (e.g., vinyl methyl ether and vinyl isobutyl ether), vinyl ketones (such as vinyl methyl ketone, vinyl ethyl ketone, vinyl isopropenyl ketone), and olefins (e.g., ethylene, propylene, butadiene), or a copolymer obtained by combining two or more kinds of monomers described above.

Examples of the resin include non-vinyl-based resins such as an epoxy resin, a polyester resin, a polyurethane resin, a polyamide resin, a cellulose resin, a polyether resin, and a modified rosin; mixtures of these non-vinyl-based resins with the vinyl-based resins; or graft polymers obtained by polymerizing a vinyl-based monomer in the coexistence of these resins.

These resins may be used alone or in combination of two or more.

These resins may be included as a binder resin. Alternatively, two or more of these resins may be included as binder resins or as a binder resin and (encapsulated) resin particles.

In particular, an amorphous resin and a crystalline resin are preferably applied as the binder resin.

Herein, the mass ratio of the crystalline resin to the amorphous resin (crystalline resin/amorphous resin) is preferably 1/99 or more and 50/50 or less, more preferably 2/98 or more and 30/70 or less, still more preferably 3/97 or more and 20/80 or less.

Here, the crystalline resin refers to a resin having a clear endothermic peak rather than a stepwise endothermic change in differential scanning calorimetry (DSC), and specifically refers to a resin whose half width of the endothermic peak measured at a rate of temperature increase of 10 (° C./min) is 10° C. or less. On the other hand, the amorphous resin refers to a resin that has a half width of higher than 10° C., demonstrates a stepwise endothermic change, or does not have a clearly recognizable endothermic peak.

Specifically, for example, the crystalline resin refers to a resin having a half width of an endothermic peak of 10° C. or less measured at a rate of temperature increase of 10° C./min, and the amorphous resin refers to a resin having a half width of higher than 10° C. or a resin not having a clearly recognizable endothermic peak.

### Amorphous Resin

The amorphous resins may be used alone or in combination of two or more. When two or more of amorphous resins are used in combination, for example, an amorphous resin having high molecular weight and an amorphous resin having a low molecular weight may be used in combination. For another example, an amorphous resin having a high glass transition temperature (Tg) and an amorphous resin having a low glass transition temperature (Tg) may be used in combination.

Examples of the amorphous resin include known amorphous resins, such as an amorphous polyester resin, an amorphous vinyl resin (e.g., a styrene acrylic resin), an epoxy resin, a polycarbonate resin, and a polyurethane resin. Among these examples, an amorphous polyester resin and an amorphous vinyl resin (in particular, a styrene acrylic resin) are preferable, and an amorphous polyester resin is more preferable. A still more preferable form of the amorphous resin includes a combination of an amorphous polyester resin and a styrene acrylic resin.

### Amorphous Polyester Resin

Examples of the amorphous polyester resin include a modified amorphous polyester resin as well as an unmodified amorphous polyester resin.

The modified amorphous polyester resin refers to an amorphous polyester resin including a bonding group other than an ester bond; or an amorphous polyester resin containing resin components different from polyester that are bonded by a covalent bond, an ionic bond, or the like.

Examples of the modified amorphous polyester resin include a resin having a modified terminal that is obtained by reacting an active hydrogen compound with an amorphous polyester resin having a terminal into which a functional group such as an isocyanate group is introduced.

A more preferable, applicable form of the amorphous polyester resin includes an amorphous resin having an amorphous polyester resin segment and a styrene-acrylic resin segment.

For the amorphous polyester resin, hydrophilicity/hydrophobicity and compatibility may be controlled by subjecting a polyester chain to terminal modification and/or grafting.

Examples of the amorphous polyester resin include condensation polymers of a polyvalent carboxylic acid and a polyhydric alcohol. The amorphous polyester resin may be a commercially available product or a synthesized product.

Examples of the polyvalent carboxylic acid include aliphatic dicarboxylic acids (e.g., oxalic acid; malonic acid; maleic acid; fumaric acid; citraconic acid; itaconic acid; glutaconic acid; succinic acid; alkenyl succinic acids such as hexenyl succinic acid, octenyl succinic acid, dodecenyl succinic acid, and pentadecenyl succinic acid and anhydrides thereof; adipic acid; and sebacic acid), alicyclic dicarboxylic acids (e.g., cyclohexanedicarboxylic acid), aromatic dicarboxylic acids (e.g., terephthalic acid, isophthalic acid, phthalic acid, and naphthalenedicarboxylic acid), anhydrides thereof, and lower alkyl esters thereof (e.g., an alkyl ester having one or more and five or less carbon atoms). Among these examples, a preferable example of the polyvalent carboxylic acid is an aromatic dicarboxylic acid.

As the polyvalent carboxylic acid, a trivalent or higher carboxylic acid having a crosslinked structure or a branched structure may be used in combination with the dicarboxylic acid. Examples of the trivalent or higher carboxylic acid include trimellitic acid, pyromellitic acid, anhydrides thereof, and lower alkyl esters thereof (e.g., an alkyl ester having one or more and five or less carbon atoms).

The polyvalent carboxylic acids may be used alone or in combination of two or more.

Examples of the polyhydric alcohol include aliphatic diols (e.g., ethylene glycol, diethylene glycol, triethylene glycol, propylene glycol, butanediol, hexanediol, and neopentyl glycol), alicyclic diols (e.g., cyclohexanediol, cyclohexanedimethanol, and hydrogenated bisphenol A), and aromatic diols (e.g., an ethylene oxide adduct of bisphenol A and a propylene oxide adduct of bisphenol A). Among these examples, the polyhydric alcohol is preferably, for example, an aromatic diol or an alicyclic diol, more preferably an aromatic diol.

As the polyhydric alcohol, a trihydric or higher polyhydric alcohol having a crosslinked structure or a branched structure may be used in combination with a diol. Examples of the trihydric or higher polyhydric alcohol include glycerin, trimethylol propane, and pentaerythritol.

The polyhydric alcohols may be used alone or in combination of two or more.

The amorphous polyester resin is obtained by a well-known production method. Specifically, for example, the amorphous polyester resin is obtained by a method of causing a reaction at a polymerization temperature adjusted to fall within the range of 180° C. or more and 230° C. or less, and if necessary, under reduced pressure in the reaction system, while removing water and alcohols generated during condensation.

The proportion of the amorphous polyester resin to the total amount of resin is preferably 60% by mass or more and 98% by mass or less, more preferably 65% by mass or more and 95% by mass or less, still more preferably 70% by mass or more and 90% by mass or less.

### Styrene Acrylic Resin

The styrene acrylic resin is a copolymer obtained by copolymerizing at least a styrenic monomer (a monomer having a styrene skeleton) and a (meth)acrylic monomer (a monomer having a (meth)acrylic group, preferably a monomer having a (meth)acryloxy group). Examples of the styrene acrylic resin include a copolymer of a monomer of styrenes with a monomer of (meth)acrylic acid esters.

The acrylic resin portion of the styrene acrylic resin is an acrylic monomer, a methacrylic monomer, or a partial structure obtained by polymerizing both an acrylic monomer and a methacrylic monomer. The term “(meth)acryl” encompasses both “acryl” and “methacryl”.

Examples of the styrenic monomer include styrene, α-methylstyrene, m-chlorostyrene, p-chlorostyrene, p-fluorostyrene, p-methoxystyrene, m-tert-butoxystyrene, p-tert-butoxystyrene, p-vinylbenzoic acid, and p-methyl-α-methylstyrene. The styrenic monomers may be used alone or in combination of two or more.

Examples of the (meth)acrylic monomer include (meth)acrylic acid, methyl (meth)acrylate, ethyl (meth)acrylate, n-propyl (meth)acrylate, isopropyl (meth)acrylate, n-butyl (meth)acrylate, isobutyl (meth)acrylate, n-hexyl (meth)acrylate, 2-ethylhexyl (meth)acrylate, lauryl (meth)acrylate, stearyl (meth)acrylate, cyclohexyl (meth)acrylate, dicyclopentanyl (meth)acrylate, isobornyl (meth)acrylate, 2-hydroxyethyl (meth)acrylate, hydroxypropyl (meth)acrylate, and 4-hydroxybutyl (meth)acrylate. The (meth)acrylic monomers may be used alone or in combination of two or more.

The polymerization ratio of the styrenic monomer to the (meth)acrylic monomer preferably satisfies, on a mass basis, styrenic monomer: (meth)acrylic monomer=70:30 to 95:5.

The styrene acrylic resin may have a crosslinked structure. The styrene acrylic resin having a crosslinked structure can be produced by, for example, copolymerizing a styrenic monomer, a (meth)acrylic monomer, and a crosslinkable monomer. The crosslinkable monomer is preferably, but not particularly limited to, a bifunctional or higher (meth)acrylate compound.

The method of producing the styrene acrylic resin is not particularly limited. Examples of an applicable method include solution polymerization, precipitation polymerization, suspension polymerization, bulk polymerization, and emulsion polymerization. A known operation (e.g., a batch operation, a semi-continuous operation, or a continuous operation) is applied to the polymerization reaction.

The proportion of the styrene acrylic resin to the total amount of resin is preferably 60% by mass or more and 98% by mass or less, more preferably 65% by mass or more and 95% by mass or less, still more preferably 70% by mass or more and 90% by mass or less.

### Polyester Resin Containing Modified Group Such as Isocyanate Group, Epoxy Group, or Urea Group (Hereinafter Also Referred to as “Modified Polyester Resin”)

Examples of the modified polyester resin include a resin obtained by reacting a polyester resin having an active hydrogen group with a compound having a modifying group such as an isocyanate group, an epoxy group, or a urea group; and a resin obtained by reacting a compound having an active hydrogen group, a polyester resin having an active hydrogen group, and a compound having a modifying group such as an isocyanate group or an epoxy group.

The active hydrogen-containing group includes at least one group selected from a hydroxyl group, a mercapto group, an amino group, a carboxyl group, a phosphate group, a sulfonate group, and a sulfate group, all of which can be easily combined with isocyanate compounds and epoxy compounds. The active hydrogen-containing group may include two or more of the above groups.

The polyester resin having an active hydrogen group is obtained by, for example, subjecting a polyvalent carboxylic acid and a polyhydric alcohol to polycondensation. As the polyvalent carboxylic acid and the polyhydric alcohol, for example, one of those exemplified above may be used alone, or two or more thereof may be used in combination.

The compound containing an active hydrogen group is not particularly limited as long as the compound has an active hydrogen group, and can be appropriately selected in accordance with the intended purpose.

When an isocyanate group is contained as the modifying group, amines may be used as the active hydrogen group-containing compound.

The amines are not particularly limited and may be appropriately selected in accordance with the intended purpose. Examples of the amines include diamines, polyamines having three or more amino groups, amino alcohols, amino mercaptans, amino acids, and these amines with a blocked amino group. Specific examples of the amines include aromatic diamines, aliphatic diamines, ethylenetriamine, triethylenetetramine, ethanolamine, hydroxyethylaniline, aminoethyl mercaptan, aminopropyl mercaptan, aminopropionic acid, aminocaproic acid, ketimine compounds obtained from any of these amines (e.g., diamines, polyamines having three or more amino groups, amino alcohols, amino mercaptans, amino acids) and ketones (e.g., acetone, methyl ethyl ketone, methyl isobutyl ketone), and oxazoline compounds.

Examples of the compound having an isocyanate group include aliphatic polyisocyanates (e.g., tetramethylene diisocyanate, hexamethylene diisocyanate, methyl 2,6-diisocyanatocaproate, octamethylene diisocyanate, decamethylene diisocyanate, dodecamethylene diisocyanate, tetradecamethylene diisocyanate, trimethylhexane diisocyanate, and tetramethylhexane diisocyanate); alicyclic polyisocyanates (e.g., isophorone diisocyanate and cyclohexylmethane diisocyanate); aromatic diisocyanates (e.g., tolylene diisocyanate, diphenylmethane diisocyanate, 1,5-naphthylene diisocyanate, diphenylene-4,4′-diisocyanate, 4,4′-diisocyanato-3,3′-dimethylbiphenyl, 3-methyldiphenylmethane-4,4′-diisocyanate, and diphenyl ether-4,4′-diisocyanate); aromatic aliphatic diisocyanates (e.g., α,α,α′,α′-tetramethylxylylene diisocyanate); isocyanurates (e.g., tris-isocyanatoalkyl-isocyanurate and triisocyanatocycloalkyl-isocyanurates); phenol derivatives of these compounds; and these compounds blocked with an oxime, a caprolactam, or the like. These compounds may be used alone or in combination of two or more.

No limitation is placed on the method of synthesizing a resin obtained by reacting a polyester resin having an active hydrogen group with a compound having a modifying group such as an isocyanate group, an epoxy group, or a urea group, and the method of synthesizing a resin obtained by reacting a compound having an active hydrogen group with a polyester resin having an active hydrogen group and with a compound having a modifying group such as an isocyanate group or an epoxy group. In the case of a resin obtained by reacting a polyester resin having an active hydrogen group with a compound having a modifying group such as an isocyanate group or an epoxy group, examples of the method include a method of synthesizing the resin by reacting a hydroxyl group-containing polyester resin obtained by the above-described well-known production method with a compound having a modifying group; and a method of synthesizing the resin by, for example, a chain extension reaction and/or a crosslinking reaction. Since the active hydrogen group is included, those having an active hydrogen group serve as a chain extender and/or a crosslinker in the chain extension reaction and/or the crosslinking reaction. The chain extension reaction and/or the crosslinking reaction may be terminated, if necessary, with a reaction terminator (e.g., diethylamine; dibutylamine; butylamine; laurylamine; and compounds obtained by blocking monoamine, such as a ketimine compound).

### Amorphous Resin Having Polyester Resin Segment and Styrene Acrylic Resin Segment (Hereinafter Also Referred to as “Hybrid Polyester Resin”)

The hybrid polyester resin is a polyester resin in which a polyester resin segment and a styrene acrylic resin segment are chemically bonded to each other.

Examples of the hybrid polyester resin include a resin having a main chain including a polyester resin and a side chain including a styrene acrylic resin chemically bonded to the main chain; a resin having a main chain including a styrene acrylic resin and a side chain including a polyester resin chemically bonded to the main chain; a resin having a main chain produced by chemically bonding a polyester resin and a styrene acrylic resin; and a resin having a main chain produced by chemically bonding a polyester resin and a styrene acrylic resin and at least one of a side chain including a polyester resin chemically bonded to the main chain and a side chain including a styrene acrylic resin chemically bonded to the main chain.

The polyester resin and the styrene acrylic resin of each segment are as described above, and the description thereof is omitted.

The proportion of the total amount of the polyester resin segment and the styrene acrylic resin segment to the total amount of the hybrid polyester resin is preferably 80% by mass or more, more preferably 90% by mass or more, still more preferably 95% by mass or more, yet still more preferably 100% by mass.

In the hybrid polyester resin, the proportion of the styrene acrylic resin segment to the total amount of the polyester resin segment and the styrene acrylic resin segment is preferably 20% by mass or more and 90% by mass or less, more preferably 25% by mass or more and 80% by mass or less, still more preferably 30% by mass or more and 70% by mass or less.

The hybrid polyester resin is preferably produced by any one of the following methods (i) to (iii):
(i) a polyester resin segment is produced by condensation polymerization of a polyhydric alcohol and a polyvalent carboxylic acid, and then monomers constituting a styrene acrylic resin segment are subjected to addition polymerization with the polyester resin segment;
(ii) a styrene acrylic resin segment is produced by addition polymerization of addition-polymerizable monomers, and then a polyhydric alcohol and a polyvalent carboxylic acid are subjected to condensation polymerization with the styrene acrylic resin segment; and
(iii) condensation polymerization of a polyhydric alcohol and a polyvalent carboxylic acid and addition polymerization of addition-polymerizable monomers are carried out in parallel.

The proportion of the hybrid polyester resin to the total amount of the binder resin is preferably 60% by mass or more and 98% by mass or less, more preferably 65% by mass or more and 95% by mass or less, still more preferably 70% by mass or more and 90% by mass or less.

### Glass Transition Temperature of Amorphous Resin

The glass transition temperature (Tg) of the amorphous resin is preferably 50° C. or more and 80° C. or less, more preferably 50° C. or more and 65° C. or less.

Note that the glass transition temperature is determined from a differential scanning calorimetry (DSC) curve obtained by DSC. More specifically, the glass transition temperature is determined conforming to the “extrapolated glass transition starting temperature” described in the method of determining a glass transition temperature in JIS K 7121-1987 “Testing Methods for Transition Temperatures of Plastics”.

### Molecular Weight of Amorphous Resin

The amorphous resin preferably has a weight-average molecular weight (Mw) of 3000 or more and 1000000 or less, more preferably 7000 or more and 500000 or less.

The amorphous resin preferably has a number-average molecular weight (Mn) of 2000 or more and 100000 or less.

The amorphous resin preferably has a molecular weight distribution Mw/Mn of 1.5 or more and 100 or less, more preferably 2 or more and 60 or less.

Note that the weight-average molecular weight and the number-average molecular weight are measured by gel permeation chromatography (GPC). The molecular weight measurement by GPC is performed using an HLC-8320GPC, which is a GPC manufactured by Tosoh Corporation, as a measurement device; a TSKgel SuperHM-M (15 cm), which is a column manufactured by Tosoh Corporation; and a tetrahydrofuran (THF) solvent. The weight-average molecular weight and the number-average molecular weight are calculated from the measurement results by using a molecular weight calibration curve plotted using a monodisperse polystyrene standard sample.

### Crystalline Resin

Examples of the crystalline resin include a crystalline polyester resin.

### Crystalline Polyester Resin

Examples of the crystalline polyester resin include polycondensates of a polyvalent carboxylic acid and a polyhydric alcohol. As the crystalline polyester resin, a commercially available product may be used, or a synthesized product may be used.

Here, since the crystalline polyester resin easily forms a crystal structure, a polycondensate using a polymerizable monomer having linear aliphatics is more preferable than that using a polymerizable monomer having aromatics. From the viewpoint of compatibility with the amorphous resin, a polycondensate using a polymerizable monomer having aromatics, the above-described modified polyester, a hybrid resin, or the like may be used.

The crystalline polyester resins may be used alone or in combination of two or more.

Examples of the polyvalent carboxylic acid include aliphatic dicarboxylic acids (e.g., oxalic acid, succinic acid, glutaric acid, adipic acid, suberic acid, azelaic acid, sebacic acid, 1,9-nonanedicarboxylic acid, 1,10-decanedicarboxylic acid, 1,12-dodecanedicarboxylic acid, 1,14-tetradecanedicarboxylic acid, and 1,18-octadecanedicarboxylic acid), aromatic dicarboxylic acids (e.g., phthalic acid, isophthalic acid, terephthalic acid, and naphthalene-2,6-dicarboxylic acid), anhydrides thereof, and lower alkyl esters (e.g., an alkyl ester having one or more and five or less carbon atoms) thereof.

As the polyvalent carboxylic acid, a trivalent or higher carboxylic acid having a crosslinked structure or a branched structure may be used in combination with the dicarboxylic acid. Examples of the trivalent or higher carboxylic acid include trimellitic acid, pyromellitic acid, anhydrides thereof, and lower alkyl esters thereof (e.g., an alkyl ester having one or more and five or less carbon atoms).

As the polyvalent carboxylic acid, a dicarboxylic acid having a sulfonate group or a dicarboxylic acid having an ethylenic double bond may be used in combination with the dicarboxylic acid.

The polyvalent carboxylic acids may be used alone or in combination of two or more.

Examples of the polyhydric alcohol include aliphatic diols (e.g., a linear aliphatic diol having two or more and 20 or less carbon atoms in the main chain portion). Examples of the aliphatic diol include ethylene glycol, 1,3-propanediol, 1,4-butanediol, 1,5-pentanediol, 1,6-hexanediol, 1,7-heptanediol, 1,8-octanediol, 1,9-nonanediol, 1,10-decanediol, 1,11-undecanediol, 1,12-dodecanediol, 1,13-tridecanediol, 1,14-tetradecanediol, 1,18-octadecanediol, and 1,20-icosanediol. Among these examples, 1,6-hexanediol, 1,8-octanediol, 1,9-nonanediol, and 1,10-decanediol are preferable as the aliphatic diol.

As the polyhydric alcohol, a trihydric or higher alcohol having a crosslinked structure or a branched structure may be used in combination with the diol. Examples of the trihydric or higher alcohol include glycerin, trimethylol ethane, trimethylol propane, and pentaerythritol.

The polyhydric alcohols may be used alone or in combination of two or more.

Here, the polyhydric alcohol preferably has an aliphatic diol content of 80 mol % or more, preferably 90 mol % or more.

The melting temperature of the crystalline polyester resin is preferably 50° C. or more and 100° C. or less, more preferably 55° C. or more and 90° C. or less, still more preferably 60° C. or more and 85° C. or less.

Note that the melting temperature is determined from a differential scanning calorimetry (DSC) curve obtained by DSC, conforming to the “melting peak temperature” described in the method of determining a melting temperature in JIS K 7121-1987 “Testing Methods for Transition Temperatures of Plastics”.

The crystalline polyester resin preferably has a weight-average molecular weight (Mw) of 6,000 or more and 50,000 or less.

The crystalline polyester resin is obtained by, for example, a well-known production method as in the amorphous polyester resin.

The content of the binder resin in the entire toner particles is, for example, preferably 40% by mass or more and 95% by mass or less, more preferably 50% by mass or more and 90% by mass or less, still more preferably 60% by mass or more and 90% by mass or less.

When the toner particles contain a binder resin as the resin particles, the toner particles may contain crosslinked resin particles as the resin particles. The crosslinkers for obtaining the crosslinked resin particles may be used alone or in combination of two or more.

The average primary particle diameter of the resin particles is preferably 10 nm or more and 500 nm or less, more preferably 20 nm or more and 300 nm or less, still more preferably 30 nm or more and 250 nm or less.

The average primary particle diameter of the resin particles is a value measured using a transmission electron microscope (TEM).

As the transmission electron microscope, for example, S4800 manufactured by Hitachi High-Tech Corporation can be used.

Specifically, a method of measuring the average primary particle diameter of resin particles is as follows.

The toner particles are cut into a piece having a thickness of about 0.1 μm with a microtome. The cross-section of the toner particle is photographed at a magnification of 10000× using the transmission electron microscope, and the equivalent circle diameter is calculated from the cross-sectional area of each of the 100 resin particles dispersed in the toner particles. Then, the arithmetic average value of the equivalent circle diameters is defined as an average primary particle diameter.

The content of the resin particles in the toner particles is preferably 0% by mass or more and 30% by mass or less, more preferably 1% by mass or more and 25% by mass or less, still more preferably 3% by mass or more and 20% by mass or less.

### Pigment

The pigment contains a fluorescent pigment. The pigment may contain a non-fluorescent pigment together with a fluorescent pigment.

The fluorescent pigment refers to an organic pigment that emits light due to external light energy.

The non-fluorescent pigment refers to an organic pigment that does not emit light due to external light energy.

In general, fluorescent pigments exhibit a color due to both reflected and emitted light, whereas non-fluorescent pigments exhibit a color due to reflected light alone.

Here, the content of the pigment in the toner particles is 4.0% by mass or more and 20.0% by mass or less, preferably 5.0% by mass or more and 18.0% by mass or less, more preferably 6.0% by mass or more and 15.0% by mass or less.

When the content of the pigment is within the above-described range, the pigment is likely to be sufficiently dispersed in the toner particles while aggregation of the pigment is suppressed. As a result, an image of an intended color can be easily obtained.

### Fluorescent Pigment

The fluorescent pigment is not limited in color or the like as long as the fluorescent pigment is an organic pigment that emits fluorescence. Examples of the fluorescent pigment include fluorescent yellow organic pigments, fluorescent pink organic pigments, fluorescent red organic pigments, fluorescent orange organic pigments, fluorescent green organic pigments, and fluorescent purple organic pigments.

Examples of the fluorescent pigment include azomethine compounds, isoindolinone compounds, xanthene compounds (including rhodamine compounds, fluorescein compounds, and eosin compounds), naphthalene compounds, and triarylmethane compounds.

Among these examples, the fluorescent pigment is preferably an azomethine compound having an emission peak wavelength of 500 nm or more and 550 nm or less, more preferably a bisazomethine compound having an emission peak wavelength of 500 nm or more and 550 nm or less. When these azomethine compounds are applied, a fluorescent yellow image having good fluorescence intensity can be formed.

Here, the emission peak wavelength is measured, for example, using a UV-3600 (spectrophotometer manufactured by SHIMADZU CORPORATION) according to the measurement method specified by Japanese Industrial Standards (JIS K 5101-3-3).

Examples of the azomethine compound include compounds having an azomethine structure represented by —R¹C═N— (where R¹ is a hydrogen atom or a monovalent substituent).

Examples of the bisazomethine compound include compounds having, in the molecular structure, a bisazomethine structure represented by —R¹C═N—N═CR²— (where R¹ and R² each independently represent a hydrogen atom or a monovalent substituent).

The fluorescent pigment preferably has a hydrophilic group.

Examples of the hydrophilic group in the fluorescent pigment include a hydroxy group, primary to tertiary amino groups, a carboxy group, a sulfo group, and a phosphate group.

Among these examples, the fluorescent pigment preferably has a hydroxy group as a hydrophilic group.

Examples of the fluorescent pigment include the following azomethine compounds (1) to (3).

### Azomethine Fluorescent Pigment

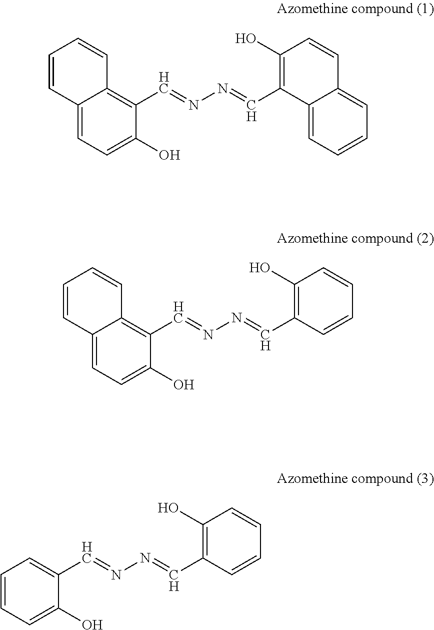 [SMILES: Oc1ccc2ccccc2c1/C=N/N=C/c1c(O)ccc2ccccc12 ; Oc1ccccc1/C=N/N=C/c1c(O)ccc2ccccc12 ; Oc1ccccc1/C=N/N=C/c1ccccc1O]

The azomethine compound (1) has an emission peak wavelength of 520 nm.

The azomethine compound (2) has an emission peak wavelength of 510 nm.

The azomethine compound (3) has an emission peak wavelength of 520 nm.

Preferred examples of the fluorescent pigment also include derivatives of azomethine compounds, and more preferred examples of the fluorescent pigment include boron difluoride derivatives of azomethine compounds.

Examples of the boron difluoride derivative of the azomethine compound include the following compound.

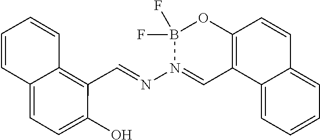

The fluorescent pigment is preferably at least one selected from the group consisting of the azomethine compound (1), the azomethine compound (2), the azomethine compound (3), and boron difluoride derivatives of these azomethine compounds.

As the fluorescent pigment, C.I. Pigment Yellow 101 or boron difluoride derivatives of C.I. Pigment Yellow 101 are preferable, and C.I. Pigment Yellow 101 represented by the azomethine compound (1) is more preferable.

The content of the fluorescent pigment in the toner particle is preferably 3.0% by mass or more and 15.0% by mass or less, more preferably 4.0% by mass or more and 13.0% by mass or less, still more preferably 5.0% by mass or more and 10.0% by mass or less.

When the content of the fluorescent pigment is 3.0% by mass or more, an image having high fluorescence intensity can be obtained.

When the content of the fluorescent pigment is 15.0% by mass or less, the pigment is easily dispersed in the toner, which suppresses an increase in particle diameter due to aggregation of the pigment. Therefore, a decrease in fluorescence intensity is suppressed.

### Non-Fluorescent Pigment

The non-fluorescent pigment is not limited in color or the like as long as the non-fluorescent pigment is an organic pigment that does not emit fluorescence. Examples of the non-fluorescent pigment include non-fluorescent green organic pigments, non-fluorescent red organic pigments, non-fluorescent yellow organic pigments, non-fluorescent pink organic pigments, non-fluorescent orange organic pigments, and non-fluorescent purple organic pigments.

Among these examples, a non-fluorescent pigment having a reflection peak wavelength of 480 nm or more and 540 nm or less (hereinafter referred to as a “specific non-fluorescent pigment”) is preferable.

In particular, when the specific non-fluorescent pigment is used in combination with the azomethine compound having an emission peak wavelength of 500 nm or more and 550 nm or less, a fluorescent green image having good fluorescence intensity can be formed.

Here, the reflection peak wavelength is measured by the same method as that in the emission peak wavelength of the fluorescent pigment described above.

From the viewpoint of reflectance, the specific non-fluorescent pigment preferably has a halogen atom.

Examples of the halogen atom in the specific non-fluorescent pigment include a fluorine atom, a chlorine atom, a bromine atom, and an iodine atom.

Among these examples, from the viewpoint of reflectance, the specific non-fluorescent pigment preferably has at least one halogen atom selected from the group consisting of a chlorine atom and a bromine atom, more preferably has a bromine atom, and particularly preferably has a chlorine atom and a bromine atom.

From the viewpoint of reflectance, the specific non-fluorescent pigment preferably has two or more halogen atoms, more preferably four or more halogen atoms, still more preferably six or more halogen atoms, and particularly preferably eight or more and 32 or less halogen atoms.

Examples of the specific non-fluorescent pigment include lake pigments of halogenated phthalocyanine compounds and halogenated triphenylmethane dyes.

As the specific non-fluorescent pigment, a halogenated phthalocyanine compound is preferable. In particular, at least one selected from the group consisting of halogenated copper phthalocyanine and halogenated zinc phthalocyanine is preferable, and halogenated copper phthalocyanine is more preferable.

Examples of the halogenated copper phthalocyanine include C.I. Pigment Green 7 (a pigment having a specific gravity of 2.1, a reflection peak wavelength of 500 nm, and 16 chlorine atoms) and C.I. Pigment Green 36 (a pigment having a specific gravity of 2.9, a reflection peak wavelength of 510 nm, and 10 chlorine atoms and six bromine atoms).

The content of the non-fluorescent pigment is selected in accordance with the fluorescent color of the fluorescent image to be obtained. The content thereof in the toner particles is preferably 1.0% by mass or more and 17.0% by mass or less, more preferably 1.5% by mass or more and 12.0% by mass or less, still more preferably 2.0% by mass or more and 8.0% by mass or less.

### Release Agent

Examples of the release agent include hydrocarbon-based waxes; natural waxes such as carnauba wax, rice wax, and candelilla wax; synthetic or mineral/petroleum waxes such as montan wax; and ester-based waxes such as a fatty acid ester and a montanic acid ester. The release agent is not particularly limited and can be appropriately selected in accordance with the intended purpose. Hydrocarbon-based waxes and ester-based waxes are preferable as the release agent.

The release agents may be used alone or in combination of two or more.

In particular, the release agent is preferably a release agent having a polar group (e.g., an ester group or a fatty acid), more preferably an ester-based wax.

When a release agent having a polar group (in particular, an ester-based wax) is applied, the release agent has an appropriate affinity for the fluorescent pigment, and the contact ratio of the pigment to the domain of the release agent is easily controlled to be within the above-described range. As a result, an image exhibiting high fluorescence intensity with reduced dot-shaped image defects can be easily obtained.

Examples of the ester-based wax include ester waxes produced from higher fatty acids having 10 or more and 30 or less carbon atoms and monohydric or polyhydric alcohols having 1 or more and 30 or less carbon atoms.

Specific examples of the ester-based wax include an ester compound of a higher fatty acid (e.g., caprylic acid, capric acid, lauric acid, myristic acid, palmitic acid, stearic acid, arachidic acid, behenic acid, and oleic acid) and an alcohol (monohydric alcohol such as methanol, ethanol, propanol, isopropanol, butanol, capryl alcohol, lauryl alcohol, myristyl alcohol, cetyl alcohol, stearyl alcohol, or oleyl alcohol; or polyhydric alcohol such as glycerin, ethylene glycol, propylene glycol, sorbitol, or pentaerythritol). More specific examples thereof include carnauba wax, rice wax, candelilla wax, jojoba oil, Japan wax, beeswax, Chinese wax, lanolin, and montanic acid ester wax.

The melting temperature of the release agent is preferably 50° C. or more and 110° C. or less, more preferably 60° C. or more and 100° C. or less.

Note that the melting temperature is determined from a differential scanning calorimetry (DSC) curve obtained by DSC, conforming to the “melting peak temperature” described in the method of determining a melting temperature in JIS K 7121-1987 “Testing Methods for Transition Temperatures of Plastics”.

The content of the release agent in the entire toner particles is, for example, preferably 1% by mass or more and 20% by mass or less, more preferably 4% by mass or more and 15% by mass or less.

The release agent may be used in a state of being contained in the resin or after being composited, if necessary. Such a resin is not particularly limited, but the above-described resin or a resin having a similar structure is preferably used from the viewpoint of compatibility.

### Other Additives

Examples of other additives include well-known additives such as a magnetic material, a charge control agent, and inorganic powder. These additives are preferably contained in the toner particles as internal additives.

The charge control agent is not particularly limited and may be appropriately selected in accordance with the intended purpose. Examples of the charge control agent include nigrosine dyes, triphenylmethane dyes, chromium-containing metal complex dyes, molybdic acid chelate pigments, rhodamine dyes, alkoxy amines, quaternary ammonium salts (including a fluorine-modified quaternary ammonium salt), alkylamides, phosphorus or phosphorus compounds, tungsten or tungsten compounds, fluorine-based activators, salicylic acid metal salts, and metal salts of a salicylic acid derivative. In a case of being used as a negatively chargeable toner, azo complex salt dyes of chromium, iron or the like; complex compounds produced from salicylic acid and chromium, zinc, aluminum, boron or the like; or charge control resins can be used as the charge control agent. The content of the charge control agent is not particularly limited and can be appropriately selected in accordance with the intended purpose. The content thereof is preferably 0.1 parts by mass or more and 10 parts by mass or less, more preferably 0.2 parts by mass or more and 5 parts by mass or less relative to 100 parts by mass of the toner.

Examples of the inorganic powder include a layered inorganic powder and a layered inorganic mineral obtained by modifying at least part of interlayer ions contained in the layered inorganic mineral with an organic ion, such as montmorillonite, bentonite, hectorite, attapulgite, sepiolite, and mixtures thereof. Among these examples, organic-modified montmorillonite or bentonite is preferable as the inorganic powder because they do not affect the toner properties, can be easily adjusted in terms of viscosity, and can be effective with a small addition amount. The inorganic powder may be used when a toner is produced by the ester extension polymerization described later. The content of the inorganic powder in the toner particles is preferably 0.2% by mass or more and 2.0% by mass or less, more preferably 0.7% by mass or more and 1.5% by mass or less.

### Properties of Toner Particles

The toner particles may be toner particles having a single-layer structure, or may be toner particles having a so-called core-shell structure including a core (core particle) and a coating layer (shell layer) with which the core is coated.

Here, the toner particles having a core-shell structure may include, for example, a core containing a resin, a pigment, and a release agent; and a coating layer containing a resin or containing a resin and a release agent. The coating layer may have a multilayer structure.

The kind of resin and the physical properties such as glass transition temperature (Tg) and SP value may be changed for the core and each layer in the coating layer.

Here, a coating layer may be formed when the toner particles are produced, or a step of forming a coating layer after completion of toner particle production may be provided.

For example, a plurality of production methods may be used, such as a method in which toner particles are produced by a kneading-pulverization method described later and then a coating layer is formed by a wet production method. Alternatively, the coating layer may be formed by causing a polymer component and/or a crosslinking component to adhere to the toner particles and then performing a polymerization reaction and/or a crosslinking reaction. The coating layer may be formed by depositing an organosilicon compound/polymer, an organotitanium compound/polymer, or the like on the surfaces of the toner particles by a sol-gel production method or the like.

The coating layer may be cured or hardened by being subjected to a surface hardening treatment with hot air or a dry mill; an amine treatment; or a surface treatment using a compound having an isocyanate group or the like, a thermosetting resin, a thermoplastic resin, or the like.

The coating layer may contain an organic component and/or an inorganic component, and may contain the resin described above or an external additive described later.

The coverage of the core with the coating layer may be adjusted depending on the intended purpose. The coating layer may cover part or all of the surface of the core depending on the intended purpose.

The volume-average particle diameter (D50v) of the toner particles is preferably 2 μm or more and 10 μm or less, more preferably 4 μm or more and 8 μm or less.

The average particle diameters and particle size distribution indices of the toner particles are measured using a Coulter Multisizer II (manufactured by Beckman Coulter, Inc.) and an ISOTON-II (manufactured by Beckman Coulter, Inc.) as a liquid electrolyte.

In the measurement, 0.5 mg or more and 50 mg or less of a sample to be measured is added to 2 ml of a 5% aqueous solution of a surfactant (preferably, sodium alkylbenzenesulfonate) as a dispersant. This is added to 100 ml or more and 150 ml or less of the liquid electrolyte.

The liquid electrolyte in which the sample is suspended is subjected to a dispersion treatment for one minute using an ultrasonic disperser, and the particle size distribution of particles having a particle diameter in the range of 1 μm or more and 30 μm or less is measured by Coulter Multisizer II using an aperture having an aperture diameter of 50 μm. The number of particles to be sampled is 50000.

Cumulative distributions by volume and number are plotted from the smaller diameter side for particle size ranges (channels) divided based on the measured particle size distribution. Particle diameters at cumulative 16% are defined as the volume particle diameter D16v and the number particle diameter D16p, particle diameters at cumulative 50% are defined as the volume-average particle diameter D50v and the number-average particle diameter D50p, and particle diameters at cumulative 84% are defined as the volume particle diameter D84v and the number particle diameter D84p.

The volume particle size distribution index (GSDv) is calculated as (D84v/D16v)^{1/2}, and the number particle size distribution index (GSDp) is calculated as (D84p/D16p)^{1/2}.

The average circularity of the toner particles is preferably 0.90 or more and 1.00 or less, and more preferably 0.92 or more and 0.98 or less.

The average circularity of the toner particles is determined from (Equivalent circle perimeter)/(Perimeter), or (Perimeter of a circle having the same projected area as the toner particle image)/(Perimeter of the projected image of the toner particle). Specifically, the average circularity of the toner particles is a value measured by the following method.

First, toner particles to be measured are collected by suction and a flat flow is formed. Then, a particle image is captured as a still image by instantaneously emitting strobe light. The average circularity is determined by using a flow particle image analyzer (Parshe Analyzer PAS, manufactured by HOSOKAWA MICRON CORPORATION) that can perform image analysis of the particle image. The number of samples for obtaining the average circularity is 10000.

When the toner contains an external additive, the toner (developer) to be measured is dispersed in water containing a surfactant, and then an ultrasonic treatment is performed to obtain toner particles from which the external additive has been removed.

### External Additive

Examples of the external additive include inorganic particles. Examples of the inorganic particles include SiO₂, TiO₂, Al₂O₃, SrTiO₃, CaTiO₃, CuO, ZnO, SnO₂, CeO₂, Fe₂O₃, MgO, BaO, CaO, K₂O, Na₂O, ZrO₂, CaO·SiO₂, K₂O·(TiO₂)ₙ, Al₂O₃·2SiO₂, CaCO₃, MgCO₃, BaSO₄, and MgSO₄.

The surfaces of the inorganic particles as an external additive are preferably hydrophobized. Hydrophobization is performed by, for example, immersing the inorganic particles in a hydrophobizing agent. The hydrophobizing agent is not particularly limited, and examples thereof include a silane-based coupling agent, silicone oil, a titanate-based coupling agent, an aluminum-based coupling agent, and other silicon compounds. The hydrophobizing agents may be used alone or in combination of two or more.

The amount of the hydrophobizing agent is usually, for example, 1 part by mass or more and 30 parts by mass or less relative to 100 parts by mass of the inorganic particles.

Examples of the external additive also include resin particles such as polystyrene, polymethyl methacrylate (PMMA), and melamine resin; and cleaning lubricants such as metal salts of higher fatty acids represented by zinc stearate, and higher alcohols.

The external addition amount of the external additive in the toner particles is, for example, preferably 0.01% by mass or more and 10% by mass or less, more preferably 0.01% by mass or more and 8.0% by mass or less.

### Method of Producing Toner

Next, a method of producing the toner according to the present exemplary embodiment will be described.

The toner according to the present exemplary embodiment is obtained by producing toner particles and then externally adding an external additive to the toner particles.

The toner particles are produced by, for example, an aggregation-coalescence method.

Specifically, for example, when toner particles are produced by an aggregation-coalescence method, toner particles are produced through the following steps:
a step of mixing a first resin particle dispersion liquid in which first resin particles serving as a binder resin are dispersed, a pigment dispersion liquid in which a pigment is dispersed, and a release agent particle dispersion liquid in which particles of a release agent (hereinafter, such a particle is also referred to as a “release agent particle”) are dispersed, and aggregating the particles and the pigment in the obtained dispersion liquid to form first aggregated particles (first aggregated particle forming step);
a step of adding, after obtaining a first aggregated particle dispersion liquid in which the first aggregated particles are dispersed, a second resin particle dispersion liquid in which second resin particles serving as a binder resin are dispersed and a pigment-/release agent particle-mixed dispersion liquid in which the pigment and the release agent particles are dispersed to the first aggregated particle dispersion liquid, and aggregating the second resin particles on the surfaces of the first aggregated particles to form second aggregated particles (second aggregated particle forming step); and
a step of heating a second aggregated particle dispersion liquid in which the second aggregated particles are dispersed and fusing and coalescing the second aggregated particles to form toner particles (fusion and coalescence step).

Here, in the method of producing toner particles by the aggregation-coalescence method, a pigment-/release agent particle-mixed dispersion liquid is preferably used in the second aggregated particle forming step. This is for the purpose of ensuring that the contact ratio of the pigment and the area fraction of the domain of the release agent fall within the above ranges.

However, the pigment-/release agent particle-mixed dispersion liquid may be used in the first aggregated particle forming step without using the pigment-/release agent particle-mixed dispersion liquid in the second aggregated particle forming step.

In the first aggregated particle forming step, the fluorescent pigment is preferably applied as the pigment in the pigment dispersion liquid in which the pigment is dispersed and in the pigment-/release agent particle-mixed dispersion liquid in which the pigment and the release agent particles are dispersed. However, the fluorescent pigment and the non-fluorescent pigment may also be used in combination.

Hereinafter, each step will be described in detail.

### Dispersion Liquids Preparation Step

First, dispersion liquids used in the aggregation-coalescence method are prepared. Specifically, the following are prepared: a first resin particle dispersion liquid in which first resin particles serving as a binder resin are dispersed; a pigment dispersion liquid in which a pigment is dispersed; a second resin particle dispersion liquid in which second resin particles serving as a binder resin are dispersed; and a release agent particle dispersion liquid in which release agent particles are dispersed.

In the dispersion liquids preparation step, the first resin particles and the second resin particles are collectively referred to as “resin particles”.

Here, the resin particle dispersion liquid is prepared by, for example, dispersing resin particles in a dispersion medium using a surfactant.

Examples of the dispersion medium used in the resin particle dispersion liquid include an aqueous medium.

Examples of the aqueous medium include water such as distilled water and ion-exchanged water; and alcohols. They may be used alone or in combination of two or more.

Examples of the surfactant include anionic surfactants such as a sulfate-based anionic surfactant, a sulfonate-based anionic surfactant, a phosphate-based anionic surfactant, and a soap-based anionic surfactant; cationic surfactants such as an amine salt-based cationic surfactant and a quaternary ammonium salt type cationic surfactant; and nonionic surfactants such as a polyethylene glycol-based nonionic surfactant, an alkylphenol ethylene oxide adduct-based nonionic surfactant, and a polyhydric alcohol-based nonionic surfactant. Among these examples, particularly preferred surfactants are anionic surfactants and cationic surfactants. The nonionic surfactant may be used in combination with an anionic surfactant or a cationic surfactant.

The surfactants may be used alone or in combination of two or more.

In the resin particle dispersion liquid, examples of the method of dispersing resin particles in a dispersion medium include general dispersion methods using a rotary shear-type homogenizer, or a ball mill, a sand mill, or a DYNO-MILL that includes media. In addition, depending on the kind of resin particles, resin particles may be dispersed in a resin particle dispersion liquid using, for example, a phase inversion emulsification method.

Note that the phase inversion emulsification method is as follows. A resin to be dispersed is dissolved in a hydrophobic organic solvent in which the resin is soluble, and a base is added to an organic continuous phase (O phase) to cause neutralization. Then, by charging an aqueous medium (W phase), the resin is converted from W/O to O/W (so-called phase inversion) and a discontinuous phase is formed, thereby dispersing the resin in the form of particles in the aqueous medium.

The volume-average particle diameter of the resin particles dispersed in the resin particle dispersion liquid is, for example, preferably 0.01 μm or more and 1 μm or less, more preferably 0.08 μm or more and 0.8 μm or less, still more preferably 0.1 μm or more and 0.6 μm or less.

The volume-average particle diameter of the resin particles is measured by using a particle size distribution obtained by measurement with a laser diffraction particle size distribution analyzer (e.g., LA-960, manufactured by HORIBA, Ltd.), drawing a cumulative distribution curve of the volume based on divided particle size ranges (channels) from the smaller particle diameter side, and measuring a particle diameter at cumulative 50% with respect to all particles as a volume-average particle diameter D50v. The volume-average particle diameter of particles in other dispersion liquids is also measured in the same manner. The content of the resin particles contained in the resin particle dispersion liquid is, for example, preferably 5% by mass or more and 50% by mass or less, more preferably 10% by mass or more and 40% by mass or less.

In the same manner as the resin particle dispersion liquid, for example, a pigment dispersion liquid and a release agent particle dispersion liquid are also prepared. That is, with regard to the volume-average particle diameter, the dispersion medium, the dispersion method, and the content of particles in the resin particle dispersion liquid, the same applies to those of the pigment dispersed in the pigment dispersion liquid, the release agent particles dispersed in the release agent particle dispersion liquid, and the pigment and the release agent particles dispersed in the pigment-/release agent particle-mixed dispersion liquid.

### First Aggregated Particle Forming Step

Next, the first resin particle dispersion liquid, the pigment dispersion liquid, and the release agent particle dispersion liquid are mixed.

In the mixed dispersion liquid, the first resin particles, the pigment, and the release agent particles are heteroaggregated to form first aggregated particles containing the first resin particles, the pigment, and the release agent particles.

Specifically, for example, an aggregating agent is added to the dispersion liquid obtained by mixing the first resin particle dispersion liquid, the pigment dispersion liquid, and the release agent particle dispersion liquid, the pH of the mixed dispersion liquid is adjusted to be acidic (e.g., pH of 2 or more and 5 or less), and a dispersion stabilizer is added, if necessary. Then, the temperature is adjusted to fall within a temperature range of 20° C. or more and 50° C. or less, and particles dispersed in the mixed dispersion liquid are aggregated to form first aggregated particles.

In the first aggregated particle forming step, for example, the above-described heating may be performed after all the processes of adding the above-described aggregating agent to the mixed dispersion liquid at room temperature (e.g., 25° C.) while stirring the mixed dispersion liquid by using a rotary shear-type homogenizer; adjusting the pH of the mixed dispersion liquid to be acidic (e.g., pH of 2 or more and 5 or less); and adding a dispersion stabilizer, if necessary.

Examples of the aggregating agent include surfactants having a polarity opposite to that of the surfactant used as the dispersant added to the mixed dispersion liquid, inorganic metal salts, and divalent or higher metal complexes. In particular, when a metal complex is used as the aggregating agent, the amount of surfactant used is reduced, which improves the charging properties.

An additive that forms a complex or a similar bond with a metal ion of the aggregating agent may be used, if necessary. A suitably used additive is a chelating agent.

Examples of the inorganic metal salt include metal salts such as calcium chloride, calcium nitrate, barium chloride, magnesium chloride, zinc chloride, aluminum chloride, and aluminum sulfate; and inorganic metal salt polymers such as polyaluminum chloride, polyaluminum hydroxide, and calcium polysulfide.

As the chelating agent, a water-soluble chelating agent may be used. Examples of the chelating agent include oxycarboxylic acids such as tartaric acid, citric acid, and gluconic acid; iminodiacetic acid (IDA); nitrilotriacetic acid (NTA); and ethylenediaminetetraacetic acid (EDTA).

The amount of the chelating agent added is, for example, preferably 0.01 parts by mass or more and 5.0 parts by mass or less, more preferably 0.1 parts by mass or more and less than 3.0 parts by mass relative to 100 parts by mass of the first resin particles.

For adjusting the effect of the chelating agent, an alkali may be added to adjust the pH in the system.

### Second Aggregated Particle Forming Step

Next, after obtaining the first aggregated particle dispersion liquid in which the first aggregated particles are dispersed, the second resin particle dispersion liquid in which the second resin particles are dispersed and the pigment-/release agent particle-mixed dispersion liquid in which the pigment and the release agent particles are dispersed are added to the first aggregated particle dispersion liquid.

Note that the second resin particles may be the same as or different from the first resin particles.

Then, in the dispersion liquid of the first aggregated particles, the pigment, the release agent particles, and the second resin particles, the second resin particles, the pigment, and the release agent particles are aggregated on the surfaces of the first aggregated particles. Specifically, for example, in the first aggregated particle forming step, when the first aggregated particles reach a target particle diameter, the second resin particle dispersion liquid and the pigment-/release agent particle-mixed dispersion liquid are added to the first aggregated particle dispersion liquid, and heating is performed at a temperature less than or equal to the glass transition temperature of the second resin particles.

Then, the progress of the aggregation is stopped by adjusting the pH of the dispersion liquid to fall within the range of, for example, about 6.5 or more and about 8.5 or less.

In this manner, the second aggregated particles in which the second resin particles, the pigment, and the release agent particles are aggregated so as to adhere to the surfaces of the first aggregated particles are obtained.

### Fusion and Coalescence Step

Next, the second aggregated particle dispersion liquid in which the second aggregated particles are dispersed is heated to, for example, a temperature higher than or equal to the glass transition temperatures of the first and second resin particles (e.g., a temperature higher than the glass transition temperatures of the first and second resin particles by a temperature of 10 to 30° C.), and the second aggregated particles are fused and coalesced to form toner particles.

If necessary, the pH in the system may be adjusted by adding an acid for controlling the shape.

Through the above steps, toner particles are obtained.

Note that, in the aggregation-coalescence method described above, toner particles may be formed by fusing and coalescing the first aggregated particles without performing the second aggregated particle forming step. The second aggregated particle forming step may be performed multiple times.

Here, after the completion of the fusion and coalescence step, the toner particles formed in the solution undergo a known washing step, solid-liquid separation step, and drying step to obtain dried toner particles.

In the washing step, sufficient displacement washing with ion-exchanged water is preferably performed from the viewpoint of chargeability. The solid-liquid separation step is not particularly limited, but suction filtration, pressure filtration, or the like is preferably performed from the viewpoint of productivity. The drying step is not particularly limited, but freeze drying, flash drying, fluidized drying, vibratory fluidized drying, or the like is preferably performed from the viewpoint of productivity.

The toner according to the present exemplary embodiment is produced, for example, by adding and mixing an external additive to the obtained dried toner particles. The mixing is preferably performed by using, for example, a V blender, a Henschel mixer, or a Lödige mixer. The external additive may be mixed with the toner particles at one time, or the external additive may be added to the toner particles stepwise and mixed with the toner particles a plurality of times. Further, if necessary, coarse particles of the toner may be removed by using a vibratory sieving machine, a wind power sieving machine, or the like.

### Electrostatic Charge Image Developer

The electrostatic charge image developer according to the present exemplary embodiment contains at least the toner according to the present exemplary embodiment.

The electrostatic charge image developer according to the present exemplary embodiment may be a one-component developer containing only the toner according to the present exemplary embodiment, or a two-component developer containing the toner and a carrier in a mixed state.

The carrier is not particularly limited, and examples thereof include known carriers. Examples of the carrier include coated carriers in which the surface of a core material including magnetic powder is coated with a coating resin; magnetic powder-dispersed carriers in which magnetic powder is dispersed and blended in a matrix resin; and resin-impregnated carriers in which porous magnetic powder is impregnated with a resin.

Note that the magnetic powder-dispersed carrier and the resin-impregnated carrier may be a carrier in which the constituent particle of the carrier is used as a core material, and the core material is coated with a coating resin.

Examples of the magnetic powder include powder of magnetic metals such as iron, nickel, and cobalt; and powder of magnetic oxides such as ferrite and magnetite. In particular, the powder of magnetite or ferrite is preferred. The magnetic powder can also be used in the form of particles dispersed in a resin.

Examples of the coating resin and the matrix resin include polyethylene, polypropylene, polystyrene, polyvinyl acetate, polyvinyl alcohol, polyvinyl butyral, polyvinyl chloride, polyvinyl ether, polyvinyl ketone, vinyl chloride-vinyl acetate copolymers, styrene-acrylic ester copolymers, straight silicone resins having an organosiloxane bond or modified products thereof, fluororesins, polyesters, polycarbonates, phenolic resins, and epoxy resins.

Note that the coating resin and the matrix resin may contain other additives such as conductive particles.

Examples of the conductive particles include particles of metals such as gold, silver, and copper; carbon black; titanium oxide; zinc oxide; tin oxide; barium sulfate; aluminum borate; and potassium titanate.

Examples of the other additives include inorganic particles; metal oxide particles such as silica, titanium oxide, zinc oxide, and tin oxide; metal compound particles such as barium sulfate, aluminum borate, and potassium titanate; and metal particles such as gold, silver, and copper.

Here, examples of the method of coating the surface of the core material with the coating resin include a method of performing coating with a coating layer forming solution in which the coating resin and, if necessary, various additives are dissolved in an appropriate solvent. The solvent is not particularly limited. It is sufficient that the solvent be selected in consideration of the coating resin to be used, coating suitability, and the like.

Specific examples of the resin coating method include an immersion method of immersing the core material in the coating layer forming solution, a spray method of spraying the coating layer forming solution onto the surface of the core material, a fluidized bed method of spraying the coating layer forming solution while floating the core material by flowing air, and a kneader coater method of mixing the core material of the carrier and the coating layer forming solution in a kneader coater and removing the solvent.

The mixing ratio (mass ratio) between the toner and the carrier in the two-component developer preferably satisfies toner:carrier=1:100 to 30:100, more preferably 3:100 to 20:100.

### Image Forming Apparatus/Image Forming Method

The image forming apparatus/image forming method according to the present exemplary embodiment will be described.

An image forming apparatus according to the present exemplary embodiment includes an image holding member, a charging device that charges a surface of the image holding member, an electrostatic charge image forming device that forms an electrostatic charge image on the surface of the image holding member that has been charged, a developing device that contains an electrostatic charge image developer and develops, using the electrostatic charge image developer, an electrostatic charge image formed on the surface of the image holding member into a toner image, a transfer device that transfers the toner image formed on the surface of the image holding member onto a surface of a recording medium, and a fixing device that fixes the toner image transferred onto the surface of the recording medium. As the electrostatic charge image developer, the electrostatic charge image developer according to the present exemplary embodiment is applied.

An image forming apparatus according to the present exemplary embodiment performs an image forming method (image forming method according to the present exemplary embodiment) including a charging step of charging a surface of an image holding member, an electrostatic charge image forming step of forming an electrostatic charge image on the surface of the image holding member that has been charged, a developing step of developing the electrostatic charge image formed on the surface of the image holding member into a toner image by using the electrostatic charge image developer according to the present exemplary embodiment, a transfer step of transferring the toner image formed on the surface of the image holding member onto a surface of a recording medium, and a fixing step of fixing the toner image transferred onto the surface of the recording medium.

To the image forming apparatus according to the present exemplary embodiment, the following well-known image forming apparatuses are applied: a direct transfer type apparatus that directly transfers a toner image formed on a surface of an image holding member onto a recording medium; an intermediate transfer type apparatus that primarily transfers a toner image formed on a surface of an image holding member onto a surface of an intermediate transfer member and secondarily transfers the toner image transferred onto the surface of the intermediate transfer member onto a surface of a recording medium; an apparatus including a cleaning device that cleans a surface of an uncharged image holding member after transfer of the toner image; and an apparatus including a discharging device that discharges a surface of an image holding member by irradiating the surface with discharging light after transfer of the toner image and before charging of the image holding member.

In the case of the intermediate transfer type apparatus, for example, the transfer device includes an intermediate transfer member having a surface onto which a toner image is transferred; a primary transfer device that primarily transfers the toner image formed on the surface of an image holding member onto the surface of the intermediate transfer member; and a secondary transfer device that secondarily transfers the toner image transferred onto the surface of the intermediate transfer member onto the surface of the recording medium.

Note that, in the image forming apparatus according to the present exemplary embodiment, for example, a portion including the developing device may have a cartridge structure (process cartridge) that is attachable to and detachable from the image forming apparatus. Examples of a suitably used process cartridge include a process cartridge including a developing device containing the electrostatic charge image developer according to the present exemplary embodiment.

Hereinafter, an example of the image forming apparatus according to the present exemplary embodiment will be described, but the present disclosure is not limited thereto. Main parts illustrated in the drawings will be described, and the description of other parts will be omitted.

In the following description, a six-unit tandem image forming apparatus in which six image forming units are arranged will be described as an example of the image forming apparatus according to the present exemplary embodiment. The tandem image forming apparatus is not limited to this, and may be a five-unit tandem image forming apparatus in which five image forming units are arranged, a four-unit tandem image forming apparatus in which four image forming units are arranged, or the like.

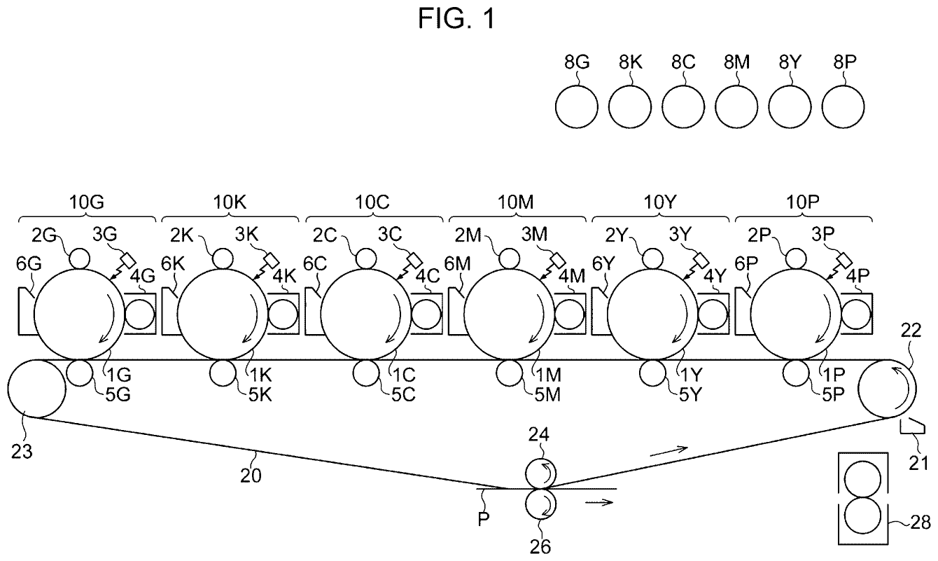

FIG. 1 is a schematic configuration view illustrating a six-unit tandem intermediate transfer type image forming apparatus as the image forming apparatus according to the present exemplary embodiment.

The image forming apparatus illustrated in FIG. 1 includes first to sixth image forming units 10P, 10Y, 10M, 10C, 10K, and 10G, which are electrophotographic image forming units for outputting images of respective colors of pink (P), yellow (Y), magenta (M), cyan (C), black (K), and green (G) based on color-separated image data. These image forming units (hereinafter, may simply be referred to as “units”) 10P, 10Y, 10M, 10C, 10K, and 10G are arranged at a predetermined distance in the horizontal direction. These units 10P, 10Y, 10M, 10C, 10K, and 10G may be process cartridges that are attachable to and detachable from the image forming apparatus.

On the lower sides of the units 10P, 10Y, 10M, 10C, 10K, and 10G, an intermediate transfer belt (an example of the intermediate transfer member) 20 extends through the units. The intermediate transfer belt 20 is provided so as to be wound around a drive roll 22, a support roll 23, and a counter roll 24, which are in contact with the inner surface of the intermediate transfer belt 20. The intermediate transfer belt 20 travels in a direction from the first unit 10P toward the sixth unit 10G. An intermediate transfer member cleaning device 21 is provided on the image holding surface side of the intermediate transfer belt 20 so as to oppose the drive roll 22.

Developing devices (an example of the developing device) 4P, 4Y, 4M, 4C, 4K, and 4G of the units 10P, 10Y, 10M, 10C, 10K, and 10G are supplied with the respective toners of pink, yellow, magenta, cyan, black, and green contained in respective toner cartridges 8P, 8Y, 8M, 8C, 8K, and 8G.

Since the first to sixth units 10P, 10Y, 10M, 10C, 10K, and 10G have an equivalent configuration and operate in the same manner, the sixth unit 10G that forms a green image will be described here as a representative.

For example, the toner according to the present exemplary embodiment described above is applied as a toner for forming a green image.

The sixth unit 10G includes a photoreceptor 1G serving as an image holding member. Around the photoreceptor 1G, the following components are arranged in the order of listing: a charging roll (an example of a charging device) 2G that charges the surface of the photoreceptor 1G to a predetermined potential; an exposure device (an example of an electrostatic charge image forming device) 3G that forms an electrostatic charge image by exposing the charged surface to a laser beam based on a color-separated image signal; a developing device (an example of a developing device) 4G that supplies the toner to the electrostatic charge image and develops the electrostatic charge image; a primary transfer roll (an example of a primary transfer device) 5G that transfers the developed toner image onto the intermediate transfer belt 20; and a photoreceptor cleaning device (an example of a cleaning device) 6G that removes toner remaining on the surface of the photoreceptor 1G after the primary transfer.

The primary transfer roll 5G is disposed inside the intermediate transfer belt 20 and is provided at a position opposing the photoreceptor 1G. A bias power supply (not illustrated) that applies a primary transfer bias is connected to each of primary transfer rolls 5Y, 5P, 5M, 5C, 5G, and 5K of the units. Each of the bias power supplies changes the value of a transfer bias applied to each of the primary transfer rolls under the control of a control unit (not illustrated).

The operation of forming a green image in the sixth unit 10G will be described below.

First, prior to the operation, the surface of the photoreceptor 1G is charged to a potential of −600 V to −800 V by the charging roll 2G.

The photoreceptor 1G is formed by laminating a photosensitive layer on a conductive substrate (e.g., having a volume resistivity of 1×10⁻⁶ Ωcm or less at 20° C.). This photosensitive layer normally has high resistance (a resistance of typical resins); however, this photosensitive layer has a property in which upon irradiation of a laser beam, the specific resistance of a portion of the photosensitive layer irradiated with the laser beam changes. In light of this property, the exposure device 3G irradiates the surface of the charged photoreceptor 1G with a laser beam in accordance with green image data sent from the control unit (not illustrated). With this process, an electrostatic charge image of a green image pattern is formed on the surface of the photoreceptor 1G.

The electrostatic charge image is an image formed on the surface of the photoreceptor 1G by charging. The electrostatic charge image is a so-called negative latent image formed as follows: a laser beam from the exposure device 3G lowers the specific resistance of the irradiated portion of the photosensitive layer; a charge flows on the surface of the photoreceptor 1G; and the charge of a portion not irradiated with the laser beam remains.

The electrostatic charge image formed on the photoreceptor 1G is rotated to a predetermined developing position due to the movement of the photoreceptor 1G. At the developing position, the electrostatic charge image on the photoreceptor 1G is developed and visualized as a toner image by the developing device 4G.

The developing device 4G contains, for example, an electrostatic charge image developer containing at least a green toner and a carrier. The green toner is subjected to triboelectrification by being stirred in the developing device 4G, and is held on a developer roll (an example of a developer holding member) having a charge of the same polarity (negative polarity) as the charge on the photoreceptor 1G. As the surface of the photoreceptor 1G passes through the developing device 4G, the green toner electrostatically adheres to the discharged latent image portion on the surface of the photoreceptor 1G, and the latent image is developed with the green toner. The photoreceptor 1G on which the green toner image has been formed continues to move at a predetermined speed, and the toner image developed on the photoreceptor 1G is transported to a predetermined primary transfer position.

When the green toner image on the photoreceptor 1G is transported to the primary transfer position, a primary transfer bias is applied to the primary transfer roll 5G, an electrostatic force heading from the photoreceptor 1G toward the primary transfer roll 5G acts on the toner image, and the toner image on the photoreceptor 1G is transferred onto the intermediate transfer belt 20. The transfer bias applied at this time has a (+) polarity opposite to the polarity (−) of the toner, and is controlled to, for example, +10 μA by a control unit (not illustrated) in the first unit 10G.

After the toner image is transferred onto the intermediate transfer belt 20, the photoreceptor 1G continues to rotate and comes into contact with the cleaning blade included in the photoreceptor cleaning device 6G. The toner remaining on the photoreceptor 1G is removed and collected by the photoreceptor cleaning device 6G.

The intermediate transfer belt 20 is sequentially transported through the first to sixth image forming units 10P, 10Y, 10M, 10C, 10K, and 10G, and the toner images of the respective colors are superimposed, so that multiple transfer is performed.

The intermediate transfer belt 20, onto which the toner images of six colors are subjected to multiple transfer through the first to sixth units, reaches a secondary transfer portion. The secondary transfer portion includes the intermediate transfer belt 20, the counter roll 24 in contact with the inner surface of the intermediate transfer belt 20, and a secondary transfer roll (an example of a secondary transfer device) 26 disposed on the image holding surface side of the intermediate transfer belt 20. On the other hand, a recording sheet (an example of a recording medium) P is fed through a supply mechanism to a portion where the secondary transfer roll 26 and the intermediate transfer belt 20 are in contact with each other and a sheet-passable gap will be created at a predetermined timing, and a secondary transfer bias is applied to the counter roll 24. The transfer bias applied at this time has a (−) polarity that is the same polarity as the polarity (−) of the toner. An electrostatic force heading from the intermediate transfer belt 20 toward the recording sheet P acts on the toner image, and the toner image on the intermediate transfer belt 20 is transferred onto the recording sheet P. This secondary transfer bias is determined in accordance with the resistance detected by a resistance detection device (not illustrated) that detects the resistance of the secondary transfer portion, and the voltage thereof is controlled.

After the toner image is transferred onto the recording sheet P, the intermediate transfer belt 20 continues to travel and comes into contact with the cleaning blade included in the intermediate transfer member cleaning device 21. The toner remaining on the intermediate transfer belt 20 is removed and collected by the intermediate transfer member cleaning device 21.

The recording sheet P onto which the toner image has been transferred is sent to a pressure contact portion (nip portion) of a pair of fixing rolls in a fixing device (an example of a fixing device) 28. The toner image is fixed on the recording sheet P, and a fixed image is formed.

Examples of the recording sheet P onto which the toner image is transferred include plain paper used in an electrophotographic copying machine, a printer, and the like. Examples of the recording medium include an overhead projector (OHP) sheet in addition to the recording sheet P.

For further improving the smoothness of the image surface after fixing, the surface of the recording sheet P is also preferably smooth. For example, coated paper obtained by coating the surface of plain paper with a resin or the like, art paper for printing, or the like is suitably used.

The recording sheet P on which the fixing of the color image has been completed is carried toward the discharge portion, and a series of color image forming operations are completed.

### Process Cartridge and Toner Cartridge

The process cartridge according to the present exemplary embodiment will be described.

The process cartridge according to the present exemplary embodiment is a process cartridge that includes a developing device containing the electrostatic charge image developer according to the present exemplary embodiment and developing the electrostatic charge image formed on the surface of the image holding member as a toner image with the electrostatic charge image developer, and that is attached to and detached from the image forming apparatus.

The configuration of the process cartridge according to the present exemplary embodiment is not limited to the above-described configuration. The process cartridge according to the present exemplary embodiment may include the developing device and, if necessary, at least one selected from other devices such as an image holding member, a charging device, an electrostatic charge image forming device, and a transfer device.

Hereinafter, an example of the process cartridge according to the present exemplary embodiment will be described, but the present disclosure is not limited thereto. In the following description, main parts illustrated in the drawings will be described, and the description of other parts will be omitted.

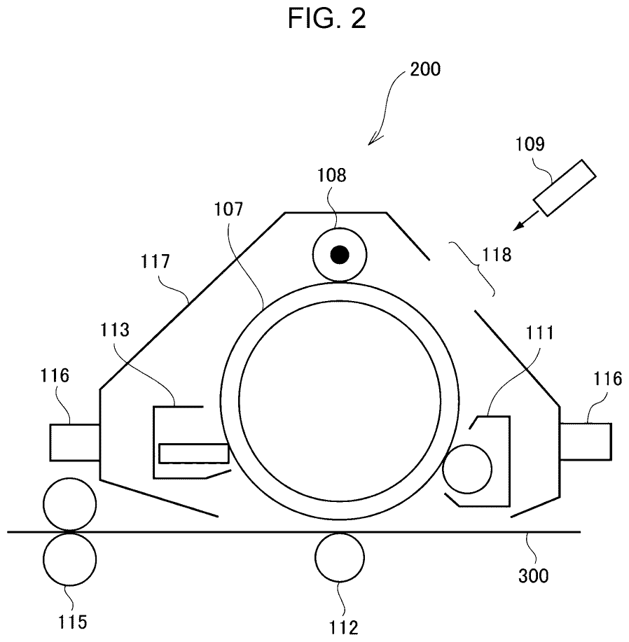

FIG. 2 is a schematic configuration view illustrating the process cartridge according to the present exemplary embodiment.

For example, a process cartridge 200 illustrated in FIG. 2 includes a housing 117 including a mounting rail 116 and an opening 118 for exposure, a photoreceptor 107 (an example of an image holding member), a charging roll 108 (an example of a charging device) provided around the photoreceptor 107, a developing device 111 (an example of a developing device), and a photoreceptor cleaning device 113 (an example of a cleaning device). In the process cartridge 200, the housing 117 integrally combines and holds the photoreceptor 107, the charging roll 108, the developing device 111, and the photoreceptor cleaning device 113 and is formed into a cartridge.

In FIG. 2, a reference numeral 109 denotes an exposure device (an example of an electrostatic charge image forming device), a reference numeral 112 denotes a transfer device (an example of a transfer device), a reference numeral 115 denotes a fixing device (an example of a fixing device), and a reference numeral 300 denotes a recording sheet (an example of a recording medium).

Next, the toner cartridge according to the present exemplary embodiment will be described.

The toner cartridge according to the present exemplary embodiment is a toner cartridge that contains the green toner according to the present exemplary embodiment and is attached to and detached from the image forming apparatus. The toner cartridge is a member for containing toner to be supplied to the developing device provided in the image forming apparatus.

The image forming apparatus illustrated in FIG. 1 is an image forming apparatus having a configuration in which the toner cartridges 8P, 8Y, 8M, 8C, 8K, and 8G are attached thereto and detached therefrom. The developing devices 4P, 4Y, 4M, 4C, 4K, and 4G are connected to the toner cartridges corresponding to the respective colors through toner supply tubes (not illustrated). When the amount of toner contained in the toner cartridge runs low, the toner cartridge will be replaced with a new one. An example of the toner cartridge according to the present exemplary embodiment is the toner cartridge 8G, which contains the toner according to the present exemplary embodiment. The toner cartridges 8P, 8Y, 8M, 8C, and 8K contain toners of pink, yellow, magenta, cyan, and black, respectively.

### EXAMPLES

Hereinafter, the exemplary embodiments of the present disclosure will be described in detail with reference to Examples, but the exemplary embodiments of the present disclosure are not limited to these Examples.

In the following description, “part(s)” and “%” are all based on mass unless otherwise specified.

Synthesis, treatment, production, and the like are performed at room temperature (25° C.±3° C.) unless otherwise specified.

### Preparation of Resin Particle Dispersion Liquid (1)

Terephthalic acid: 30 parts by mole
Fumaric acid: 70 parts by mole
Bisphenol A ethylene oxide adduct: 5 parts by mole
Bisphenol A propylene oxide adduct: 95 parts by mole

The above-described materials are charged into a flask equipped with a stirrer, a nitrogen inlet tube, a temperature sensor, and a rectifying column, the temperature is raised to 220° C. over one hour, and 1 part of titanium tetraethoxide is charged into 100 parts of the above-described materials. The temperature is raised to 230° C. over 30 minutes while the generated water is distilled off, and the dehydration condensation reaction is continued for one hour at the same temperature. Thereafter, the reaction product is cooled. In this manner, a polyester resin having a weight-average molecular weight of 18,000 and a glass transition temperature of 60° C. is obtained.

A vessel equipped with a temperature adjuster and a nitrogen purge unit is charged with 40 parts of ethyl acetate and 25 parts of 2-butanol to obtain a mixed solvent, and 100 parts of the polyester resin is gradually added thereto and dissolved. A 10%-by-mass ammonia aqueous solution (an amount equivalent to 3 times the acid value of the resin in terms of molar ratio) is added thereto, and the mixture is stirred for 30 minutes. Next, the inside of the vessel is purged with dry nitrogen, the temperature is maintained at 40° C., and 400 parts of ion-exchanged water is added dropwise to the liquid mixture at a rate of 2 parts/min under stirring. After completion of the dropwise addition, the temperature is returned to room temperature (20° C. to 25° C.), and the mixture is bubbled with dry nitrogen for 48 hours under stirring to reduce the concentrations of ethyl acetate and 2-butanol to 1,000 ppm or less, thereby obtaining a resin particle dispersion liquid. The solid content is adjusted to 20% by mass by adding ion-exchanged water to the resin particle dispersion liquid, thereby obtaining a resin particle dispersion liquid (1).

### Preparation of Fluorescent Pigment Dispersion Liquid (1)

Fluorescent yellow pigment (C.I. Pigment Yellow 101 (Radglo VSF-0-01, manufactured by Radiant Color NV, emission peak wavelength: 520 nm)): 70 parts
Anionic surfactant (NEOGEN RK, manufactured by DKS Co., Ltd.): 30 parts (solid content: 20%)·
Ion-exchanged water: 200 parts

The above components are mixed and pulverized to a size of 0.3 μm using a continuous key mill (KMC-3) to adjust the solid content to 20% by mass, thereby obtaining a fluorescent pigment dispersion liquid (1) having a volume-average particle diameter of 300 nm.

### Preparation of Fluorescent Pigment Dispersion Liquid (2)

A fluorescent pigment dispersion liquid (2) having a volume-average particle diameter of 300 nm is obtained in the same manner as the fluorescent pigment dispersion liquid (1), except that the fluorescent yellow pigment is changed to a fluorescent pigment (C.I. Basic Red 1:1, manufactured by Taoka Chemical Co., Ltd.).

### Preparation of Fluorescent Pigment Dispersion Liquid (3)

A fluorescent pigment dispersion liquid (3) having a volume-average particle diameter of 300 nm is obtained in the same manner as the fluorescent pigment dispersion liquid (1), except that the fluorescent yellow pigment is changed to a fluorescent green pigment (SINLOIHI COLOR FZ-2002, manufactured by SINLOIHI Co., Ltd.).

### Preparation of Non-Fluorescent Pigment Dispersion Liquid (1)

Non-fluorescent green pigment (C.I. Pigment Green 36 (LIONOL GREEN 8624, manufactured by TOYOCOLOR Co., Ltd., reflection peak wavelength: 510 nm)): 70 parts
Anionic surfactant (NEOGEN RK, manufactured by DKS Co., Ltd.): 30 parts (solid content: 20%)
Ion-exchanged water: 200 parts

The above components are mixed and pulverized to a size of 0.2 μm using a continuous key mill (KMC-3) to adjust the solid content to 20% by mass, thereby obtaining a non-fluorescent pigment dispersion liquid (1) having a volume-average particle diameter of 50 nm.

### Preparation of Non-fluorescent Pigment Dispersion Liquid (2)

A non-fluorescent pigment dispersion liquid (2) having a volume-average particle diameter of 50 nm is obtained in the same manner as the non-fluorescent pigment dispersion liquid (1), except that the non-fluorescent green pigment is changed to C.I. Pigment Red 122 RE-05 (manufactured by DIC Corporation).

### Preparation of Release Agent Particle Dispersion Liquid (1)

Ester-based wax (Nissan Electol WEP-5, manufactured by NOF Corporation): 100 parts
Anionic surfactant (NEOGEN RK, manufactured by DKS Co., Ltd.): 1 part
Ion-exchanged water: 350 parts

The above-described materials are mixed, heated to 100° C., and dispersed by using a homogenizer (ULTRA-TURRAX T 50, manufactured by IKA-Werke GmbH & Co. KG). Then, the dispersed mixture is subjected to a dispersion treatment by using a Manton-Gaulin high-pressure homogenizer (Manton-Gaulin Company), thereby obtaining a release agent particle dispersion liquid (1) (solid content: 20% by mass) in which release agent particles having a volume-average particle diameter of 200 nm are dispersed.

### Preparation of Release Agent Particle Dispersion Liquid (2)

A release agent particle dispersion liquid (2) having a volume-average particle diameter of 200 nm is obtained in the same manner as the release agent particle dispersion liquid (1), except that the ester wax is changed to “Nissan Electol WEP-8” manufactured by NOF Corporation.

### Preparation of Release Agent Particle Dispersion Liquid (3)

A release agent particle dispersion liquid (3) having a volume-average particle diameter of 200 nm is obtained in the same manner as the release agent particle dispersion liquid (1), except that the ester-based wax is changed to carnauba wax.

### Preparation of Release Agent Particle Dispersion Liquid (4)

A release agent particle dispersion liquid (4) having a volume-average particle diameter of 200 nm is obtained in the same manner as the release agent particle dispersion liquid (1), except that the ester-based wax is changed to paraffin wax (“HNP-9”, manufactured by Nippon Seiro Co., Ltd.).

### Preparation of Fluorescent Pigment/Release Agent Particle Dispersion Liquid (1)

Ester-based wax (Nissan Electol WEP-5, manufactured by NOF Corporation): 100 parts
Anionic surfactant (NEOGEN RK, manufactured by DKS Co., Ltd.): 1 part
Fluorescent pigment dispersion liquid (1): 30 parts
Ion-exchanged water: 350 parts

The above-described materials are mixed and heated to 100° C. and dispersed by using a homogenizer (ULTRA-TURRAX T 50, manufactured by IKA-Werke GmbH & Co. KG). Then, the dispersed mixture is subjected to a dispersion treatment by using a Manton-Gaulin high-pressure homogenizer (Manton-Gaulin Company), thereby obtaining a fluorescent pigment/release agent particle dispersion liquid (1) (solid content: 23% by mass) in which release agent particles having a volume-average particle diameter of 60 nm and a fluorescent pigment having a volume-average particle diameter of 200 nm are dispersed.

### Preparation of Fluorescent Pigment/Release Agent Particle Dispersion Liquid (2)

A fluorescent pigment/release agent particle dispersion liquid (2) is obtained in the same manner as the fluorescent pigment/release agent particle dispersion liquid (1), except that the fluorescent pigment dispersion liquid (1) is changed to the fluorescent pigment dispersion liquid (2).

### Preparation of Fluorescent Pigment/Release Agent Particle Dispersion Liquid (3)

A fluorescent pigment/release agent particle dispersion liquid (3) is obtained in the same manner as the fluorescent pigment/release agent particle dispersion liquid (1), except that the fluorescent pigment dispersion liquid (1) is changed to the fluorescent pigment dispersion liquid (3).

### Preparation of Fluorescent Pigment/Release Agent Particle Dispersion Liquid (4)

A fluorescent pigment/release agent particle dispersion liquid (4) is obtained in the same manner as the fluorescent pigment/release agent particle dispersion liquid (1), except that the ester-based wax is changed to carnauba wax.

### Preparation of Fluorescent Pigment/Release Agent Particle Dispersion Liquid (5)

A fluorescent pigment/release agent particle dispersion liquid (5) is obtained in the same manner as the fluorescent pigment/release agent particle dispersion liquid (1), except that the ester-based wax is changed to paraffin wax (“HNP-9”, manufactured by Nippon Seiro Co., Ltd.).

### Example 1

### Production of Toner Particles (1)

Resin particle dispersion liquid (1): 400 parts
Fluorescent pigment dispersion liquid (1): 50 parts
Non-fluorescent pigment dispersion liquid (1): 25 parts
Release agent particle dispersion liquid (1): 5 parts
Anionic surfactant (DKS Co., Ltd.: NEOGEN RK, 20%): 10 parts

The above-described materials are placed in a round stainless steel flask, 0.1 N (i.e., mol/L) of nitric acid is added to adjust the pH to 3.5, and 30 parts of a nitric acid aqueous solution having a polyaluminum chloride concentration of 10% by mass is added.

Next, the mixture is dispersed at a liquid temperature of 30° C. using a homogenizer (product name: ULTRA-TURRAX T 50, manufactured by IKA-Werke Gmbh & Co. KG), heated to 45° C. in a heating oil bath, and held for 30 minutes.

Thereafter, 50 parts of the resin particle dispersion liquid (1) and 20 parts of the fluorescent pigment/release agent particle dispersion liquid (1) are added and held for one hour.

The pH is then adjusted to 8.5 by adding a 0.1 N sodium hydroxide aqueous solution, and the mixture is heated to 84° C. and held for 2.5 hours.

The mixture is then cooled to 20° C. at a rate of 20° C./min, and the solid matter is separated by filtration, sufficiently washed with ion-exchanged water, and dried to obtain toner particles. The obtained toner particles have a volume-average particle diameter of 5.8 μm.

### Production of Toner

Using a sample mill, 100 parts by mass of toner particles and 3.0 parts by mass of silica particles (“RY50” manufactured by NIPPON AEROSIL CO., LTD.) are mixed and blended at 10,000 revolutions per minute (rpm) for 30 seconds. Thereafter, the resulting mixture is sieved through a vibrating sieve having an opening of 45 μm to obtain a toner (electrostatic charge image developing toner).

### Production of Developer

A V blender is charged with 10 parts of the obtained toner and 100 parts of the carrier described below, and the materials are stirred for 20 minutes. The mixture is sieved using a sieve having an opening of 212 μm to obtain a cyan developer.

### Carrier

Cyclohexyl methacrylate resin (weight-average molecular weight 50000): 54 parts
Carbon black (VXC72, manufactured by Cabot Corporation): 6 parts
Toluene: 250 parts
Isopropyl alcohol: 50 parts

The above-described materials and glass beads (diameter: 1 mm, the same amount as toluene) are charged into a sand mill and stirred at a rotation speed of 190 rpm for 30 minutes to obtain a coating agent.

Into a kneader, 1000 parts of ferrite particles (volume-average particle diameter: 35 μm) and 150 parts of the coating agent are charged, and both are mixed at room temperature (25° C.) for 20 minutes. Then, the mixture is heated to 70° C. under reduced pressure and dried. The dried product is cooled to room temperature (25° C.), taken out from the kneader, and sieved by using a mesh having an opening of 75 μm to remove coarse powder, thereby obtaining a carrier.

### Example 2

Toner particles are obtained in the same manner as in Example 1, except that the ratio of materials to be additionally added in the method of producing the toner particles (1) is changed to the following: 50 parts of the resin particle dispersion liquid (1), 10 parts of the release agent particle dispersion liquid (1), and 10 parts of the fluorescent pigment/release agent particle dispersion liquid (1).

Then, the obtained toner particles are used to obtain a toner and a developer in the same manner as in Example 1.

### Example 3

Toner particles are obtained in the same manner as in Example 1, except that the ratio of materials to be additionally added in the method of producing the toner particles (1) is changed to the following: 50 parts of the resin particle dispersion liquid (1), 12 parts of the release agent particle dispersion liquid (1), and 18 parts of the fluorescent pigment/release agent particle dispersion liquid (1).

Then, the obtained toner particles are used to obtain a toner and a developer in the same manner as in Example 1.

### Comparative Example 1

Toner particles are obtained in the same manner as in Example 1, except that the ratio of materials to be additionally added in the method of producing the toner particles (1) is changed to the following: 50 parts of the resin particle dispersion liquid (1), 15 parts of the release agent particle dispersion liquid (1), and 5 parts of the fluorescent pigment/release agent particle dispersion liquid (1).

Then, the obtained toner particles are used to obtain a toner and a developer in the same manner as in Example 1.

### Example 4

Toner particles are obtained in the same manner as in Example 1, except that 1 part of the fluorescent pigment/release agent particle dispersion liquid (1) is added to the materials initially charged (the materials initially charged into the round stainless steel flask) in the method of producing the toner particles (1).

Then, the obtained toner particles are used to obtain a toner and a developer in the same manner as in Example 1.

### Example 5

Toner particles are obtained in the same manner as in Example 1, except that 2 parts of the fluorescent pigment/release agent particle dispersion liquid (1) are added to the materials initially charged (the materials initially charged into the round stainless steel flask) in the method of producing the toner particles (1).

Then, the obtained toner particles are used to obtain a toner and a developer in the same manner as in Example 1.

### Comparative Example 2

Toner particles are obtained in the same manner as in Example 1, except that 3 parts of the fluorescent pigment/release agent particle dispersion liquid (1) are added to the materials initially charged (the materials initially charged into the round stainless steel flask) in the method of producing the toner particles (1).

Then, the obtained toner particles are used to obtain a toner and a developer in the same manner as in Example 1.

### Example 6

Toner particles are obtained in the same manner as in Example 1, except that the fluorescent pigment dispersion liquid (1), the non-fluorescent pigment dispersion liquid (1), and the fluorescent pigment/release agent particle dispersion liquid (1) are changed to the fluorescent pigment dispersion liquid (2), the non-fluorescent pigment dispersion liquid (2), and the fluorescent pigment/release agent particle dispersion liquid (2), respectively.

Then, the obtained toner particles are used to obtain a toner and a developer in the same manner as in Example 1.

### Example 7

Toner particles are obtained in the same manner as in Example 6, except that 20 parts of the fluorescent pigment/release agent particle dispersion liquid (2) are changed to 10 parts of the release agent particle dispersion liquid (1) and 10 parts of the fluorescent pigment/release agent particle dispersion liquid (2).

Then, the obtained toner particles are used to obtain a toner and a developer in the same manner as in Example 6.

### Comparative Example 3

Toner particles are obtained in the same manner as in Example 6, except that 20 parts of the fluorescent pigment/release agent particle dispersion liquid (2) are changed to 15 parts of the release agent particle dispersion liquid (1) and 5 parts of the fluorescent pigment/release agent particle dispersion liquid (2).

Then, the obtained toner particles are used to obtain a toner and a developer in the same manner as in Example 6.

### Example 8

Toner particles are obtained in the same manner as in Example 6, except that 2 parts of the fluorescent pigment/release agent particle dispersion liquid (2) are added to the materials initially charged.

Then, the obtained toner particles are used to obtain a toner and a developer in the same manner as in Example 6.

### Comparative Example 4

Toner particles are obtained in the same manner as in Example 6, except that 3 parts of the fluorescent pigment/release agent particle dispersion liquid (2) are added to the materials initially charged (the materials initially charged into the round stainless steel flask).

Then, the obtained toner particles are used to obtain a toner and a developer in the same manner as in Example 6.

### Example 10

Toner particles are obtained in the same manner as in Example 1, except that the amounts of the materials initially charged (the materials initially charged into the round stainless steel flask) of the fluorescent pigment dispersion liquid (1), the non-fluorescent pigment dispersion liquid (1), the release agent particle dispersion liquid (1), and the fluorescent pigment/release agent particle dispersion liquid (1) are changed to 65 parts, 0 parts, 10 parts, and 10 parts, respectively, as well as that the amount of the fluorescent pigment/release agent particle dispersion liquid (1) to be added later is changed to 15 parts.

Then, the obtained toner particles are used to obtain a toner and a developer in the same manner as in Example 1.

### Example 11

Toner particles are obtained in the same manner as in Example 10, except that the amount of the material initially charged (the materials initially charged into the round stainless steel flask) of the fluorescent pigment/release agent particle dispersion liquid (1) is changed to 12 parts, as well as that the amount of the fluorescent pigment/release agent particle dispersion liquid (1) to be added later is changed to 13 parts.

Then, the obtained toner particles are used to obtain a toner and a developer in the same manner as in Example 10.

### Example 12

Toner particles are obtained in the same manner as in Example 10, except that the amounts of the materials initially charged (the materials initially charged into the round stainless steel flask) of the resin particle dispersion liquid (1), the fluorescent pigment dispersion liquid (1), the non-fluorescent pigment dispersion liquid (1), the release agent particle dispersion liquid (1), and the fluorescent pigment/release agent particle dispersion liquid (1) are changed to 350 parts, 65 parts, 0 parts, 5 parts, and 7 parts, respectively, as well as that the amounts of the resin particle dispersion liquid (1) and the fluorescent pigment/release agent particle dispersion liquid (1) to be added later are changed to 55 parts and 23 parts, respectively.

Then, the obtained toner particles are used to obtain a toner and a developer in the same manner as in Example 10.

### Example 13

Toner particles are obtained in the same manner as in Example 10, except that the amounts of the materials initially charged (the materials initially charged into the round stainless steel flask) of the resin particle dispersion liquid (1), the fluorescent pigment dispersion liquid (1), the non-fluorescent pigment dispersion liquid (1), the release agent particle dispersion liquid (1), and the fluorescent pigment/release agent particle dispersion liquid (1) are changed to 350 parts, 65 parts, 0 parts, 5 parts, and 5 parts, respectively, as well as that the amounts of the resin particle dispersion liquid (1) and the fluorescent pigment/release agent particle dispersion liquid (1) to be added later are changed to 55 parts and 25 parts, respectively.

Then, the obtained toner particles are used to obtain a toner and a developer in the same manner as in Example 10.

### Example 14

Toner particles are obtained in the same manner as in Example 10, except that the amounts of the materials initially charged (the materials initially charged into the round stainless steel flask) of the resin particle dispersion liquid (1), the fluorescent pigment dispersion liquid (1), the non-fluorescent pigment dispersion liquid (1), the release agent particle dispersion liquid (1), and the fluorescent pigment/release agent particle dispersion liquid (1) are changed to 350 parts, 65 parts, 0 parts, 3 parts, and 5 parts, respectively, as well as that the amounts of the resin particle dispersion liquid (1) and the fluorescent pigment/release agent particle dispersion liquid (1) to be added later are changed to 55 parts and 27 parts, respectively.

Then, the obtained toner particles are used to obtain a toner and a developer in the same manner as in Example 10.

### Example 15

Toner particles are obtained in the same manner as in Example 10, except that the materials are heated to a heating oil bath temperature of 43° C. and held for 25 minutes.

Then, the obtained toner particles are used to obtain a toner and a developer in the same manner as in Example 10.

### Example 16

Toner particles are obtained in the same manner as in Example 10, except that the materials are heated to a heating oil bath temperature of 42° C. and held for 30 minutes.

Then, the obtained toner particles are used to obtain a toner and a developer in the same manner as in Example 10.

### Example 17

Toner particles are obtained in the same manner as in Example 10, except that the materials are heated to a heating oil bath temperature of 43° C. and held for 45 minutes, as well as that 50 parts of the resin particle dispersion liquid (1) and 20 parts of the fluorescent pigment/release agent particle dispersion liquid (1) are thereafter added and the resulting mixture is held for 1.2 hours.

Then, the obtained toner particles are used to obtain a toner and a developer in the same manner as in Example 10.

### Example 18

Toner particles are obtained in the same manner as in Example 10, except that the materials are heated to a heating oil bath temperature of 43° C. and held for 45 minutes, as well as that 50 parts of the resin particle dispersion liquid (1) and 20 parts of the fluorescent pigment/release agent particle dispersion liquid (1) are thereafter added and the resulting mixture is held for 1.5 hours.

Then, the obtained toner particles are used to obtain a toner and a developer in the same manner as in Example 10.

### Example 19

Toner particles are obtained in the same manner as in Example 10, except that the materials are heated to a heating oil bath temperature of 42° C. and held for 25 minutes, as well as that 50 parts of the resin particle dispersion liquid (1) and 20 parts of the fluorescent pigment/release agent particle dispersion liquid (1) are thereafter added and the resulting mixture is heated to a temperature of 43° C.

Then, the obtained toner particles are used to obtain a toner and a developer in the same manner as in Example 10.

### Example 20

Toner particles are obtained in the same manner as in Example 10, except that the materials are heated to a heating oil bath temperature of 42° C. and held for 25 minutes, as well as that 50 parts of the resin particle dispersion liquid (1) and 20 parts of the fluorescent pigment/release agent particle dispersion liquid (1) are thereafter added and the resulting mixture is heated to a temperature of 43° C. and held for 45 minutes.

Then, the obtained toner particles are used to obtain a toner and a developer in the same manner as in Example 10.

### Example 21

Toner particles are obtained in the same manner as in Example 10, except that the materials are heated to a heating oil bath temperature of 45° C. and held for 35 minutes, as well as that 50 parts of the resin particle dispersion liquid (1) and 20 parts of the fluorescent pigment/release agent particle dispersion liquid (1) are thereafter added and the resulting mixture is heated to a temperature of 45° C. and held for 75 minutes.

Then, the obtained toner particles are used to obtain a toner and a developer in the same manner as in Example 10.

### Example 22

Toner particles are obtained in the same manner as in Example 10, except that the materials are heated to a heating oil bath temperature of 45° C. and held for 45 minutes, as well as that 50 parts of the resin particle dispersion liquid (1) and 20 parts of the fluorescent pigment/release agent particle dispersion liquid (1) are thereafter added and the resulting mixture is heated to a temperature of 45° C. and held for 90 minutes.

Then, the obtained toner particles are used to obtain a toner and a developer in the same manner as in Example 10.

### Example 23

Toner particles are obtained in the same manner as in Example 10, except that the release agent particle dispersion liquid (1) is changed to the release agent particle dispersion liquid (2).

Then, the obtained toner particles are used to obtain a toner and a developer in the same manner as in Example 10.

### Example 24

Toner particles are obtained in the same manner as in Example 23, except that 50 parts of the resin particle dispersion liquid (1) and 20 parts of the fluorescent pigment/release agent particle dispersion liquid (1) are added, and the mixture is heated to a temperature of 45° C. and held for 45 minutes.

Then, the obtained toner particles are used to obtain a toner and a developer in the same manner as in Example 23.

### Example 25

Toner particles are obtained in the same manner as in Example 23, except that the pH is adjusted to 9.0 by adding a 0.1 N sodium hydroxide aqueous solution, and the mixture is heated to 84° C. and held for 3.0 hours.

Then, the obtained toner particles are used to obtain a toner and a developer in the same manner as in Example 23.

### Example 26

Toner particles are obtained in the same manner as in Example 23, except that the pH is adjusted to 9.0 by adding a 0.1 N sodium hydroxide aqueous solution, and the mixture is heated to 85° C. and held for 3.0 hours.

Then, the obtained toner particles are used to obtain a toner and a developer in the same manner as in Example 23.

### Example 27

Toner particles are obtained in the same manner as in Example 1, except that the materials are heated to 40° C. in a heating oil bath and held for 30 minutes.

Then, the obtained toner particles are used to obtain a toner and a developer in the same manner as in Example 1.

### Example 28

Toner particles are obtained in the same manner as in Example 1, except that the materials are heated to 40° C. in a heating oil bath and held for 25 minutes.

Then, the obtained toner particles are used to obtain a toner and a developer in the same manner as in Example 1.

### Example 29

Toner particles are obtained in the same manner as in Example 1, except that the materials are heated to 43° C. in a heating oil bath and held for 30 minutes, and thereafter held at 45° C. for 30 minutes.

Then, the obtained toner particles are used to obtain a toner and a developer in the same manner as in Example 1.

### Example 30

Toner particles are obtained in the same manner as in Example 1, except that the materials are heated to 43° C. in a heating oil bath and held for 40 minutes, and thereafter held at 45° C. for 30 minutes

Then, the obtained toner particles are used to obtain a toner and a developer in the same manner as in Example 1.

### Example 31

Toner particles are obtained in the same manner as in Example 1, except that the fluorescent pigment dispersion liquid is changed to the fluorescent pigment dispersion liquid (3), the amount of the non-fluorescent pigment dispersion liquid (1) is changed to 0 parts, and the fluorescent pigment/release agent particle dispersion liquid is changed to the fluorescent pigment/release agent particle dispersion liquid (3).

Then, the obtained toner particles are used to obtain a toner and a developer in the same manner as in Example 1.

### Example 32

Toner particles are obtained in the same manner as in Example 1, except that the release agent particle dispersion liquid is changed to the release agent particle dispersion liquid (3) and the fluorescent pigment/release agent particle dispersion liquid is changed to the fluorescent pigment/release agent particle dispersion liquid (4).

Then, the obtained toner particles are used to obtain a toner and a developer in the same manner as in Example 1.

### Example 33

Toner particles are obtained in the same manner as in Example 1, except that the release agent particle dispersion liquid is changed to the release agent particle dispersion liquid (4) and the fluorescent pigment/release agent particle dispersion liquid is changed to the fluorescent pigment/release agent particle dispersion liquid (5).

Then, the obtained toner particles are used to obtain a toner and a developer in the same manner as in Example 1.

### Evaluation

### Properties

The following properties of the toners of Examples 1 to 33 and Comparative Examples 1 to 4 are measured by the method described above.
The contact ratio of the pigment to the domain of the release agent
The area fraction of the domain of the release agent present in the region within a distance of 0.3×d from the surfaces of the toner particle in the direction of the center of gravity of the cross-section of the toner particle, where d represents a volume-average particle diameter of toner particles (in the table, stated as “Area fraction of domain of release agent at surface layer of toner particle”)
The ratio of the dispersion diameter of the fluorescent pigment to the domain diameter of the release agent
The dispersion diameter of the fluorescent pigment
The domain diameter of the release agent
The ratio of the dispersion diameter of the fluorescent pigment to the dispersion diameter of the non-fluorescent pigment

### Evaluation Using Actual Device

A developing device “Iridesse Production Press” manufactured by FUJIFILM Business Innovation Corp. is filled with each of the developers obtained in Examples 1 to 33 and Comparative Examples 1 to 4.

The obtained image forming apparatus is used as an image forming apparatus for evaluation.

The image forming apparatus for evaluation is left to stand overnight in an environment of 30° C. and 85% RH, and then images each having an image density of 15% are output on 100000 double-sided A4 sheets. The output sheets are left to stand overnight.

Thereafter, the following evaluations are performed.

### White Dot/Black Dot-Shaped Image Defect

The amount of toner used for developing monochromatic 100% images is adjusted to 2.0 g/m², and a blank image and a 50%-halftone full image are output on the OS coated paper manufactured by FUJIFILM Business Innovation Corp.

The white dots/black dots are observed in the obtained images, thereby performing evaluation according to the following evaluation criteria.

A+: The number of white dots/black dots having a diameter of 10 μm or more and 500 μm or less is zero.

A: The number of white dots/black dots having a diameter of 10 μm or more and 500 μm or less is two or less.

B: The number of white dots/black dots having a diameter of 10 μm or more and 500 μm or less is five or less.

C: The number of white dots/black dots having a diameter of 10 μm or more and 500 μm or less is 10 or less.

D: The number of white dots/black dots having a diameter of 10 μm or more and 500 μm or less is more than 10.

### Fluorescence Intensity

The amount of toner used for developing monochromatic 100% images is adjusted to 4.5 g/m², and a 5 cm×5 cm-sized image formed only by the toner is output on the OS coated paper manufactured by FUJIFILM Business Innovation Corp.

Using X-Rite 939 (manufactured by X-Rite, Inc., aperture: 4 mm), the spectral reflectance in the visible light region is calculated by measuring the spectral reflectance at 10 random positions in the image plane and averaging the measured values.

The spectral reflectance of the fluorescent pigment is measured and calculated by the same method as described above, except that the toners are produced by using materials from which only the non-fluorescent pigment is removed in the method of producing the toner in each Example.

The spectral reflectance of the non-fluorescent pigment is measured and calculated by the same method as described above, except that the toners are produced by using materials from which only the fluorescent pigment is removed in the method of producing the toner in each Example.

A+: The spectral reflectance at the peak wavelength is 82% or more.

A: The spectral reflectance at the peak wavelength is 80% or more.

B: The spectral reflectance at the peak wavelength is 70% or more and less than 80%.

C: The spectral reflectance at the peak wavelength is less than 70%.

TABLE 1-1

| | | | | | | | Ratio of |
|---|---|---|---|---|---|---|---|
| | | Area | Ratio of | | | | dispersion |
| | | fraction | dispersion | | | | diameter of |
| | | of domain | diameter of | | | | fluorescent |
| | | of release | fluorescent | | | | pigment to |
| | | agent at | pigment to | | | Dispersion | dispersion |
| | | surface | domain | Dispersion | Domain | diameter of | diameter |
| | Contact | layer | diameter | diameter of | diameter of | non- | of non- |
| | ratio of | of toner | of release | fluorescent | release | fluorescent | fluorescent |
| | pigment | particle | agent | pigment | agent | pigment | pigment |
| | % | % | — | nm | nm | nm | — |
| Example 1 | 22 | 60 | 0.47 | 534 | 1132 | 52 | 0.10 |
| Example 2 | 10 | 60 | 0.42 | 521 | 1232 | 49 | 0.09 |
| Example 3 | 6 | 65 | 0.39 | 450 | 1143 | 50 | 0.11 |
| Comparative | 4 | 70 | 0.54 | 600 | 1112 | 50 | 0.08 |
| Example 1 | | | | | | | |
| Example 4 | 25 | 66 | 0.46 | 520 | 1130 | 52 | 0.10 |
| Example 5 | 28 | 58 | 0.47 | 524 | 1124 | 52 | 0.10 |
| Comparative | 32 | 60 | 0.46 | 531 | 1153 | 52 | 0.10 |
| Example 2 | | | | | | | |
| Example 6 | 18 | 62 | 0.37 | 350 | 950 | 120 | 0.34 |
| Example 7 | 6 | 66 | 0.40 | 330 | 820 | 120 | 0.36 |
| Comparative | 3 | 68 | 0.41 | 330 | 810 | 120 | 0.36 |
| Example 3 | | | | | | | |
| Example 8 | 27 | 61 | 0.42 | 345 | 820 | 120 | 0.35 |
| Comparative | 34 | 62 | 0.42 | 345 | 830 | 120 | 0.35 |
| Example 4 | | | | | | | |
| Example 10 | 22 | 53 | 0.53 | 630 | 1200 | — | — |
| Example 11 | 19 | 45 | 0.53 | 635 | 1200 | — | — |
| Example 12 | 20 | 70 | 0.53 | 630 | 1200 | — | — |
| Example 13 | 20 | 88 | 0.53 | 632 | 1200 | — | — |
| Example 14 | 20 | 93 | 0.53 | 635 | 1200 | — | — |
| Example 15 | 22 | 70 | 0.10 | 140 | 1400 | — | — |
| Example 16 | 19 | 72 | 0.09 | 140 | 1500 | — | — |
| Example 17 | 23 | 73 | 0.79 | 820 | 1044 | — | — |
| Example 18 | 25 | 71 | 0.81 | 850 | 1055 | — | — |
| Example 19 | 21 | 65 | 0.10 | 50 | 500 | — | — |
| Example 20 | 20 | 64 | 0.10 | 48 | 500 | — | — |
| Example 21 | 20 | 63 | 0.56 | 790 | 1400 | — | — |
| Example 22 | 23 | 63 | 0.59 | 820 | 1400 | — | — |
| Example 23 | 24 | 60 | 0.75 | 75 | 100 | — | — |
| Example 24 | 25 | 62 | 0.77 | 75 | 98 | — | — |
| Example 25 | 24 | 61 | 0.55 | 820 | 1490 | — | — |
| Example 26 | 23 | 63 | 0.54 | 820 | 1520 | — | — |
| Example 27 | 23 | 65 | 0.58 | 780 | 1350 | 40 | 0.05 |
| Example 28 | 24 | 66 | 0.58 | 780 | 1350 | 35 | 0.04 |
| Example 29 | 25 | 67 | 0.56 | 780 | 1400 | 380 | 0.49 |
| Example 30 | 23 | 65 | 0.56 | 780 | 1400 | 420 | 0.54 |
| Example 31 | 25 | 65 | 0.40 | 480 | 1200 | 230 | 0.48 |
| Example 32 | 25 | 65 | 0.37 | 520 | 1400 | 200 | 0.38 |
| Example 33 | 25 | 65 | 0.43 | 520 | 1200 | 200 | 0.38 |

TABLE 1-2

| | | | | White | |
|---|---|---|---|---|---|
| | Release | | Non-fluorescent | dot/ | |
| | agent | Fluorescent pigment | pigment | Black | Fluorescence |
| | — | — | — | dot | intensity |
| Example 1 | esterwax | C.I. Pigment Yellow 101 | C.I. Pigment Green 36 | A+ | A+ |
| Example 2 | esterwax | C.I. Pigment Yellow 101 | C.I. Pigment Green 36 | A | A |
| Example 3 | esterwax | C.I. Pigment Yellow 101 | C.I. Pigment Green 36 | B | A |
| Comparative | esterwax | C.I. Pigment Yellow 101 | C.I. Pigment Green 36 | D | A |
| Example 1 | | | | | |
| Example 4 | esterwax | C.I. Pigment Yellow 101 | C.I. Pigment Green 36 | A | A |
| Example 5 | esterwax | C.I. Pigment Yellow 101 | C.I. Pigment Green 36 | A | B |
| Comparative | esterwax | C.I. Pigment Yellow 101 | C.I. Pigment Green 36 | B | D |
| Example 2 | | | | | |
| Example 6 | esterwax | C.I. Basic Red 1:1 | C.I. Pigment Red 122 | A+ | A+ |
| Example 7 | esterwax | C.I. Basic Red 1:1 | C.I. Pigment Red 122 | C | A |
| Comparative | esterwax | C.I. Basic Red 1:1 | C.I. Pigment Red 122 | D | A |
| Example 3 | | | | | |
| Example 8 | esterwax | C.I. Basic Red 1:1 | C.I. Pigment Red 122 | B | B |
| Comparative | esterwax | C.I. Basic Red 1:1 | C.I. Pigment Red 122 | B | D |
| Example 4 | | | | | |
| Example 10 | esterwax | C.I. Pigment Yellow 101 | — | A | B |
| Example 11 | esterwax | C.I. Pigment Yellow 101 | — | A | B |
| Example 12 | esterwax | C.I. Pigment Yellow 101 | — | A | A |
| Example 13 | esterwax | C.I. Pigment Yellow 101 | — | B | A |
| Example 14 | esterwax | C.I. Pigment Yellow 101 | — | C | A |
| Example 15 | esterwax | C.I. Pigment Yellow 101 | — | B | B |
| Example 16 | esterwax | C.I. Pigment Yellow 101 | — | C | B |
| Example 17 | esterwax | C.I. Pigment Yellow 101 | — | A | B |
| Example 18 | esterwax | C.I. Pigment Yellow 101 | — | A | C |
| Example 19 | esterwax | C.I. Pigment Yellow 101 | — | A | B |
| Example 20 | esterwax | C.I. Pigment Yellow 101 | — | A | C |
| Example 21 | esterwax | C.I. Pigment Yellow 101 | — | B | A |
| Example 22 | esterwax | C.I. Pigment Yellow 101 | — | C | A |
| Example 23 | esterwax | C.I. Pigment Yellow 101 | — | A | B |
| Example 24 | esterwax | C.I. Pigment Yellow 101 | — | C | B |
| Example 25 | esterwax | C.I. Pigment Yellow 101 | — | B | A |
| Example 26 | esterwax | C.I. Pigment Yellow 101 | — | C | A |
| Example 27 | esterwax | C.I. Pigment Yellow 101 | C.I. Pigment Green 36 | B | B |
| Example 28 | esterwax | C.I. Pigment Yellow 101 | C.I. Pigment Green 36 | B | C |
| Example 29 | esterwax | C.I. Pigment Yellow 101 | C.I. Pigment Green 36 | B | A |
| Example 30 | esterwax | C.I. Pigment Yellow 101 | C.I. Pigment Green 36 | C | B |
| Example 31 | esterwax | FZ-2002 | — | A | A |
| Example 32 | Carnauba | C.I. Pigment Yellow 101 | C.I. Pigment Green 36 | B | B |
| | wax | | | | |
| Example 33 | HNP-9 | C.I. Pigment Yellow 101 | C.I. Pigment Green 36 | C | C |

As can be seen from the above results, images exhibiting higher fluorescence intensity with more reduced dot-shaped image defects can be formed in Examples than in Comparative Examples.

### APPENDIX

(((1)))

An electrostatic charge image developing toner comprising:
a toner particle containing a binder resin, a pigment containing a fluorescent pigment, and a release agent, wherein
when a cross-section of the toner particle is observed, the cross-section includes a domain of the release agent, and
a contact ratio of the pigment to the domain of the release agent is 5% or more and 30% or less.
   (((2)))

The electrostatic charge image developing toner according to (((1))), wherein the contact ratio of the pigment is 10% or more and 25% or less.

(((3)))

The electrostatic charge image developing toner according to (((1))) or (((2))), wherein when the cross-section of the toner particle is observed, an area fraction of the domain of the release agent present in a region within a distance of 0.3×d from a surface of the toner particle in a direction of a center of gravity of the cross-section of the toner particle is 50% or more and 90% or less, where d is a volume-average particle diameter of toner particles.

(((4)))

The electrostatic charge image developing toner according to (((3))), wherein the area fraction of the domain of the release agent is 50% or more and 70% or less.

(((5)

The electrostatic charge image developing toner according to any one of (((1)) to wherein when the cross-section of the toner particle is observed, a ratio of a dispersion diameter of the fluorescent pigment to a domain diameter of the release agent is 1/10 or more and 4/5 or less.

(((6)))

The electrostatic charge image developing toner according to (((5))), wherein when the cross-section of the toner particle is observed, the fluorescent pigment has a dispersion diameter of 50 nm or more and 800 nm or less.

(((7)))

The electrostatic charge image developing toner according to (((5))) or (((6))), wherein when the cross-section of the toner particle is observed, the release agent has a domain diameter of 100 nm or more and 1500 nm or less.

(((8)))

The electrostatic charge image developing toner according to any one of (((1))) to (((7))), wherein
the pigment contains a non-fluorescent pigment, and
a ratio of a dispersion diameter of the fluorescent pigment to a dispersion diameter of the non-fluorescent pigment is 1/25 or more and 1/2 or less.
   (((9))

The electrostatic charge image developing toner according to any one of (((1))) to (((8))), wherein the release agent is a release agent having a polar group.

(((10)))

The electrostatic charge image developing toner according to (((9))), wherein the release agent having the polar group is an ester-based wax.

(((11)))

The electrostatic charge image developing toner according to any one of (((1))) to (((10))), wherein the fluorescent pigment contains an azomethine compound having an emission peak wavelength of 500 nm or more and 550 nm or less.

(((12)))

The electrostatic charge image developing toner according to (((11))), wherein the pigment contains a non-fluorescent pigment having a reflection peak wavelength of 480 nm or more and 540 nm or less.

(((13)))

An electrostatic charge image developer comprising the electrostatic charge image developing toner according to any one of (((1))) to (((12))).

(((14)))

A toner cartridge that contains the electrostatic charge image developing toner according to any one of (((1))) to (((12))), and is attached to and detached from an image forming apparatus.

(((15)))

A process cartridge that is attached to and detached from an image forming apparatus, the process cartridge comprising a developing device configured to contain the electrostatic charge image developer according to (((13))) and develop, using the electrostatic charge image developer, an electrostatic charge image formed on a surface of an image holding member into a toner image.

(((16)))

An image forming apparatus comprising:
an image holding member;
a charging device configured to charge a surface of the image holding member;
an electrostatic charge image forming device configured to form an electrostatic charge image on the surface of the image holding member that has been charged;
a developing device configured to contain the electrostatic charge image developer according to (((13))) and develop, using the electrostatic charge image developer, the electrostatic charge image formed on the surface of the image holding member into a toner image;
a transfer device configured to transfer the toner image formed on the surface of the image holding member onto a surface of a recording medium; and
a fixing device configured to fix the toner image transferred onto the surface of the recording medium.

What is claimed is:

1. An electrostatic charge image developing toner comprising:
a toner particle containing a binder resin, a pigment containing a fluorescent pigment, and a release agent,
wherein when a cross-section of the toner particle is observed, the cross-section includes a domain of the release agent, and
a contact ratio of the pigment to the domain of the release agent is 5% or more and 30% or less.

2. The electrostatic charge image developing toner according to claim 1, wherein the contact ratio of the pigment is 10% or more and 25% or less.

3. The electrostatic charge image developing toner according to claim 1, wherein when the cross-section of the toner particle is observed, an area fraction of the domain of the release agent present in a region within a distance of 0.3× d from a surface of the toner particle in a direction of a center of gravity of the cross-section of the toner particle is 50% or more and 90% or less, where d is a volume-average particle diameter of toner particles.

4. The electrostatic charge image developing toner according to claim 3, wherein the area fraction of the domain of the release agent is 50% or more and 70% or less.

5. The electrostatic charge image developing toner according to claim 1, wherein when the cross-section of the toner particle is observed, a ratio of a dispersion diameter of the fluorescent pigment to a domain diameter of the release agent is 1/10 or more and 4/5 or less.

6. The electrostatic charge image developing toner according to claim 5, wherein when the cross-section of the toner particle is observed, the fluorescent pigment has a dispersion diameter of 50 nm or more and 800 nm or less.

7. The electrostatic charge image developing toner according to claim 5, wherein when the cross-section of the toner particle is observed, the release agent has a domain diameter of 100 nm or more and 1500 nm or less.

8. The electrostatic charge image developing toner according to claim 1, wherein
the pigment contains a non-fluorescent pigment, and
a ratio of a dispersion diameter of the fluorescent pigment to a dispersion diameter of the non-fluorescent pigment is 1/25 or more and 1/2 or less.

9. The electrostatic charge image developing toner according to claim 1, wherein the release agent is a release agent having a polar group.

10. The electrostatic charge image developing toner according to claim 9, wherein the release agent having the polar group is an ester-based wax.

11. The electrostatic charge image developing toner according to claim 1, wherein the fluorescent pigment contains an azomethine compound having an emission peak wavelength of 500 nm or more and 550 nm or less.

12. The electrostatic charge image developing toner according to claim 11, wherein the pigment contains a non-fluorescent pigment having a reflection peak wavelength of 480 nm or more and 540 nm or less.

13. An electrostatic charge image developer comprising the electrostatic charge image developing toner according to claim 1.

14. An electrostatic charge image developer comprising the electrostatic charge image developing toner according to claim 2.

15. An electrostatic charge image developer comprising the electrostatic charge image developing toner according to claim 3.

16. An electrostatic charge image developer comprising the electrostatic charge image developing toner according to claim 4.

17. An electrostatic charge image developer comprising the electrostatic charge image developing toner according to claim 5.

18. A toner cartridge that contains the electrostatic charge image developing toner according to claim 1, and is attached to and detached from an image forming apparatus.

19. A process cartridge that is attached to and detached from an image forming apparatus, the process cartridge comprising a developing device configured to contain the electrostatic charge image developer according to claim 13 and develop, using the electrostatic charge image developer, an electrostatic charge image formed on a surface of an image holding member into a toner image.

20. An image forming apparatus comprising:
an image holding member;
a charging device configured to charge a surface of the image holding member;
an electrostatic charge image forming device configured to form an electrostatic charge image on the surface of the image holding member that has been charged;
a developing device configured to contain the electrostatic charge image developer according to claim 13 and develop, using the electrostatic charge image developer, the electrostatic charge image formed on the surface of the image holding member into a toner image;
a transfer device configured to transfer the toner image formed on the surface of the image holding member onto a surface of a recording medium; and
a fixing device configured to fix the toner image transferred onto the surface of the recording medium.
